(19) United States
(12) Patent Application Publication
(10) Pub. No.: US 2024/0419521 A1
(43) Pub. Date: Dec. 19, 2024

(54) SYSTEMS AND METHODS FOR RESOURCE ALLOCATION FOR INTENT SIGNAL OBJECT GENERATION

(71) Applicant: Loop Commerce, Inc., Stamford, CT (US)

(72) Inventor: Gabriel Saunkeah, Stamford, CT (US)

(21) Appl. No.: 18/739,461

(22) Filed: Jun. 11, 2024

Related U.S. Application Data
(60) Provisional application No. 63/508,398, filed on Jun. 15, 2023.

(51) Int. Cl. G06F 9/54; G06F 9/50

(52) U.S. Cl. CPC G06F 9/548; G06F 9/5016; G06F 2209/5022

(57) ABSTRACT

A system is provided for generating dynamic objects in response to detected intent signals. The system receives a request to generate a dynamic object through an object placement implemented through a network object and in response to an intent signal. The request indicates a resource amount allocated for the request. The system identifies other requests and determines whether the resource amount is greater than other resource amounts associated with the other requests. If so, the system obtains a set of assets corresponding to the dynamic object and, in response to detecting the intent signal in real-time, uses the assets to generate the dynamic object through the object placement.

### CROSS-REFERENCE TO RELATED APPLICATIONS

The present patent application claims the priority benefit of U.S. Provisional Patent Application 63/508,398 filed Jun. 15, 2023, the disclosures of which are incorporated by reference herein.

### FIELD

The present disclosure relates to systems and methods for soliciting and processing resource amount allocations associated with different object placements corresponding to different intent signals. In response to detecting an intent signal, the systems and methods automatically identify a set of assets corresponding to a highest resource amount allocation for generation and placement of one or more objects corresponding to the intent signal.

### SUMMARY

Disclosed embodiments provide a framework for soliciting and processing resource amount allocations associated with different object placements corresponding to different intent signals. According to some embodiments, a computer-implemented method is provided. The computer-implemented method comprises receiving a request to generate a dynamic object through an object placement in response to an intent signal. The request indicates a resource amount allocated for the request. Further, the object placement is implemented through a network object. The computer-implemented method further comprises identifying other requests to generate other dynamic objects through the object placement in response to the intent signal. The other requests indicate other resource amounts for the other requests. The computer-implemented method further comprises obtaining a set of assets corresponding to the dynamic object. The set of assets are obtained as a result of the resource amount allocated for the request being greater than the other resource amounts. The computer-implemented method further comprises detecting in real-time the intent signal. The intent signal is detected in real-time in response to user access to the network object. The computer-implemented method further comprises generating the dynamic object. The dynamic object is generated using the set of assets. Further, the dynamic object is generated through the object placement.

In some embodiments, the computer-implemented method further comprises dynamically training in real-time a machine learning algorithm to customize dynamic objects according to received user data. The machine learning algorithm is dynamically trained in real-time using sample user data and feedback corresponding to dynamic objects generated according to the user data. The computer-implemented method further comprises customizing the dynamic object according to the user access. The dynamic object is customized by the machine learning algorithm based on the user access.

In some embodiments, the computer-implemented method further comprises assigning a pairing of the object placement to the intent signal to a requesting system associated with the request as a result of the resource amount allocated for the request being greater than the other resource amounts. The pairing is assigned to the requesting system subject to an expiration date after which the pairing is made available to other systems.

In some embodiments, the object placement is associated with one or more application programming interfaces (APIs) that are exposed when the network object is accessed. Further, when the user access is performed, the APIs are used to detect the intent signal.

In some embodiments, the set of assets are obtained as a result of the resource amount allocated for the request being greater than a reserve resource amount designated for the object placement and the intent signal.

In some embodiments, the set of assets are obtained as a result of a number corresponding to the other requests being greater than a minimum number of requests designated for the object placement and the intent signal.

In some embodiments, the set of assets include configuration information corresponding to the object placement. Further, when the dynamic object is generated, the configuration information is used to configure the object placement for the dynamic object.

In an embodiment, a system comprises one or more processors and memory including instructions that, as a result of being executed by the one or more processors, cause the system to perform the processes described herein. In another embodiment, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 shows an illustrative example of an environment in which an intent signal object generation service automatically and in real-time processes bids corresponding to object placements associated with an intent signal for generation of objects using assets corresponding to a highest bid and upon detection of the intent signal in accordance with at least one embodiment;

FIG. 2 shows an illustrative example of an environment in which an object placement request processor automatically and in real-time processes incoming bids for different object placements corresponding to different intent signals to assign sets of assets for the different object placements in accordance with at least one embodiment;

FIGS. 3A-3B show an illustrative example of an environment in which an intent signal and object bid processor automatically and in real-time evaluates bids received from different third-party systems for object placements associated with a particular intent signal to determine which assets are to be associated with these object placements in accordance with at least one embodiment;

FIG. 4 shows an illustrative example of an environment in which an object request sub-system dynamically provides available assets and configuration information corresponding to objects associated with a particular intent signal for generation of these objects in response to the particular intent signal in accordance with at least one embodiment;

FIG. 5 shows an illustrative example of an environment in which an object generation module dynamically and in real-time generates an object on a webpage using assets associated with a highest bid and in response to a detected intent signal in accordance with at least one embodiment;

FIG. 6 shows an illustrative example of an environment in which an object generation module dynamically and in real-time generates an object using assets associated with a highest bid and in response to an intent signal corresponding to the presentation of one or more gift selection categories for generating a gift for a recipient in accordance with at least one embodiment;

FIG. 7 shows an illustrative example of an environment in which an object generation module dynamically and in real-time generates an object using assets associated with a highest bid and in response to an intent signal corresponding to a request to generate a gift associated with a particular gift category in accordance with at least one embodiment;

FIG. 8 shows an illustrative example of an environment in which an object generation module dynamically and in real-time generates an object using assets associated with a highest bid and in response to an intent signal corresponding to a request to redeem a gift associated with a particular gift category in accordance with at least one embodiment;

FIG. 9 shows an illustrative example of a process for associating a set of assets corresponding to a set of object placements associated with a particular intent signal based on received bids for the set of object placements in accordance with at least one embodiment;

FIG. 10 shows an illustrative example of a process for associated a set of assets corresponding to a set of object placements associated with a reserved intent signal based on requests from authorized third-party systems associated with the reserved intent signal in accordance with at least one embodiment;

FIG. 11 shows an illustrative example of a process for dynamically generating one or more objects corresponding to a detected intent signal using a set of assets corresponding a highest bid obtained for object placements associated with the intent signal in accordance with at least one embodiment; and

FIG. 12 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Disclosed embodiments may provide a framework to dynamically generate and present different dynamic objects through object placements according to detected intent signals. Through this framework, an intent signal object generation service can automatically process bids from different third-party systems for different object placement to intent signal pairings, whereby a third-party system submitting a highest bid for a particular pairing may provide different assets that may be used to generate dynamic objects within an object placement on a website, application, or other network object in response to a detected intent signal.

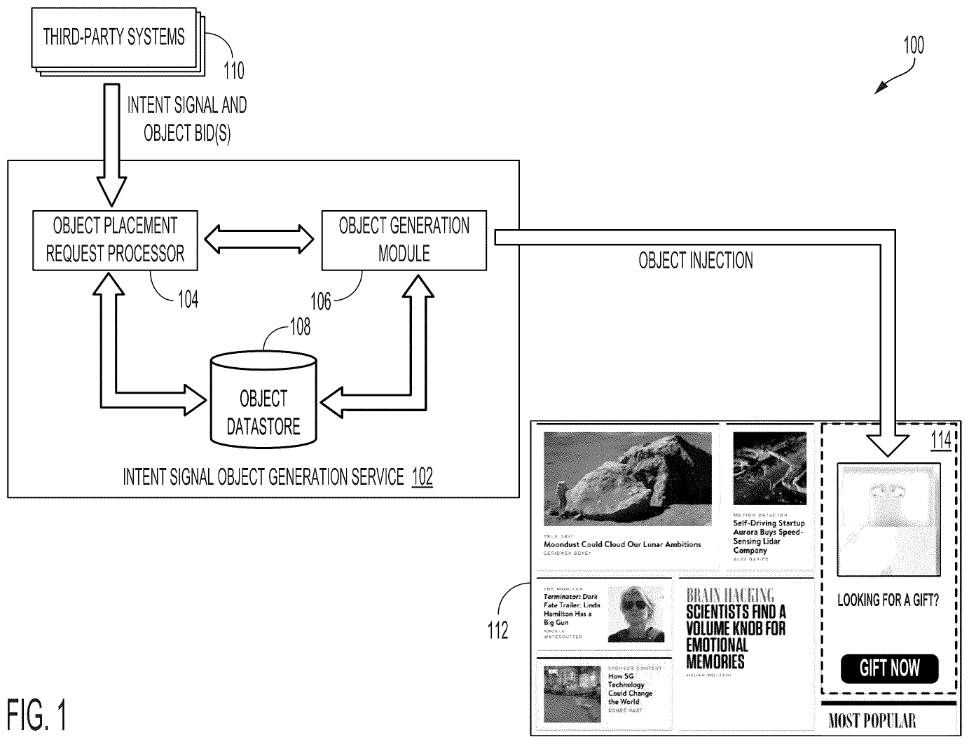

FIG. 1 shows an illustrative example of an environment 100 in which an intent signal object generation service 102 automatically and in real-time processes bids corresponding to object placements associated with an intent signal for generation of objects 114 using assets corresponding to a highest bid and upon detection of the intent signal in accordance with at least one embodiment. In the environment 100, an intent signal object generation service 102 obtains, in real-time, different bids corresponding to available object placements associated with different intent signals. The object placements may allow for the creation and presentation of dynamic objects that may be used to request creation of a gift object that may be delivered to a particular recipient. For example, the intent signal object generation service 102 may maintain one or more available object placements corresponding to different platforms through which dynamic objects may be presented through these available object placements to allow for users to request generation of gift objects to different recipients. As an illustrative example, and as illustrated in FIG. 1, an available object placement may correspond to a portion of a website 112. This particular object placement may allow for the presentation of a dynamic object 114 that may prominently highlight a set of assets corresponding to a set of possible gift objects that may be selected as a gift for a particular recipient. The particular object placement may alternatively allow for the presentation of a dynamic object 114 that may prominently highlight one or more items that may be of interest to a user based on the content being presented on the website 112 or on any contextual information available about the user, as described in greater detail herein.

The object placements that are made available by the object generation service 102 may be obtained and made available through different methods. For instance, the object generation service 102 may purchase these available object placements from different purveyors of the websites (such as website 112), applications, platforms, and/or other network resources that may be accessible to users. Returning to the illustrative example illustrated in FIG. 1, a purveyor of the website 112 (e.g., a retailer, a news agency, a webmaster, etc.) may make available for purchase different object placements through which dynamic objects may be presented. These different object placements may initially be devoid of any association to any intent signals. For instance, a purchaser of an object placement may configure the object placement to present a particular dynamic object regardless of the user's intent in accessing the underlying platform. These resulting dynamic object may, thus, be irrelevant to the user's intent in accessing the platform. In an embodiment, the object generation service 102 can purchase, lease, or otherwise obtain these object placements from the purveyor of the corresponding platform and associate these object placements with different intent signals. As described in greater detail herein, each pairing of an available object pairing to a particular intent signal may be made available to third-party systems 110, whereby these third-party systems 110 may configure the object placement to present different dynamic objects according to the detected intent signal. In some instances, the object generation service 102 may implement these different object placements without having to purchase, lease, or otherwise obtain these different object placements from purveyors of the underlying platforms through which the object placements are made available.

In some instances, the object placements may allow for the creation and presentation of dynamic objects 114 that may be selected to request redemption of a gift object associated with the presented dynamic objects 114. For example, a dynamic object 114 presented within a particular object placement may include a set of assets corresponding to featured gift objects associated with a particular gift category selected by a recipient. For instance, if a recipient of a gift accesses a website to redeem the gift and selected a particular gift category, the intent signal object generation service 102 may identify an object placement corresponding to the website and the particular gift category. Based on this identification of the object placement, the intent signal object generation service 102 may dynamically generate a dynamic object 114 within the object placement that incorporates one or more assets corresponding to possible gift objects that may be redeemed for the gift and associated with the selected gift category.

An object placement may include a location within a website, application interface, or other user interface through which an advertisement may be presented to users accessing the website, application interface, or other user interface. For instance, as illustrated in FIG. 1, the website 112 may include a designated location through which different advertisements may be generated and presented to users. Thus, the dynamic objects 114 that may be generated and presented through an object placement may include different advertisements associated with different third-party systems 110 according to the detected intent signal.

An intent signal may include any data obtained by the intent signal object generation service 102 based on content presented to users through websites, applications, or other user interfaces. For example, when a user navigates to a particular website, the intent signal object generation service 102 may automatically, and in real-time, evaluate the particular website for one or more intent signals that may be used to generate a dynamic object 114 within any of the object placements available to the intent signal object generation service 102 on the particular website. As an illustrative example, if the user navigates to a website 112 that includes a news article that was updated on or near Mother's Day, the intent signal object generation service 102 may automatically, and in real-time, detect an intent signal corresponding to Mother's Day. Based on the intent signal, the intent signal object generation service 102 may automatically, and in real-time, identify any assets corresponding to a dynamic object 114 that is associated with the intent signal corresponding to “Mother's Day” and that may be presented within any of the object placements available to the intent signal object generation service 102 on the particular website. For example, the dynamic object 114 may include a caption such as “Mother's Day Is Almost Here!,” which may inform the user that Mother's Day is approaching. Further, the intent signal object generation service 102, through the dynamic object 114, may provide the user with any associated assets that may correspond to the intent signal corresponding to “Mother's Day.” These associated assets may include, for example, one or more gift options that may be purchased and delivered to a recipient for Mother's Day. These associated assets may include one or more images or other product details corresponding to different products that may be requested and delivered to a recipient as a gift from the user.

In some instances, identifying information corresponding to the user may be used by the intent signal object generation service 102 to further detect one or more intent signals that may be used to generate the dynamic object 114 within an object placement on the particular website. For example, through a cookie implemented on a user's computing device, the intent signal object generation service 102 may obtain demographic information about the user (e.g., gender, nationality, ethnicity, etc.) that may be used to detect the user's possible intent. Through the cookie, the intent signal object generation service 102 may collect clickstream data, search data, purchase data, user profile data, and the like. As an illustrative example, through the cookie, the intent signal object generation service 102 may automatically determine that the user is male, 21-39 years old, and American. If the user visits a website associated with a retailer of women's clothing within a few days of Mother's Day, the intent signal object generation service 102 may automatically determine that the user is likely searching for a Mother's Day gift for someone in their life (e.g., their mother, their spouse, etc.). Accordingly, the intent signal object generation service 102 may detect an intent signal corresponding to the user's desire to purchase a Mother's Day gift for someone. Based on this intent signal, the intent signal object generation service 102 may identify a dynamic object 114 that may be presented through an available object placement on the website.

As another illustrative example of an intent signal, if a user navigates to a website associated with a retailer system (such as a point-of-sale system, etc.) and the user selects a particular item made available through the retailer system, the intent signal object generation service 102 may automatically, and in real-time, detect an intent signal corresponding to the user's selection of this particular item. The particular item may correspond to a particular item category or may be independent of any item category. Further, the particular item, through the particular item category or other characteristic, may be associated with other items or item categories through the intent signal. As an illustrative example, if the user selects, from the website, a particular item, the selection of the particular item may be interpreted as an intent signal corresponding to a likelihood of the user requesting the particular item for their own purposes. Accordingly, based on this intent signal, the intent signal object generation service 102 may automatically, and in real-time, determine whether the particular item is associated with other items or item categories that may be presented to the user through a dynamic object 114 that is associated with the intent signal. The intent signal object generation service 102 may identify any assets corresponding to a dynamic object 114 that is associated with this intent signal (e.g., assets corresponding to an item from the set of other items or item categories associated with the selected item, etc.) to provide these assets to the user through the dynamic object 114. For example, if the user has selected, from the website, a particular video game for purchase, the user's selection of this particular video game may serve as an intent signal that may be used to identify an item that is closely associated with the purchase of the particular video game and that may be presented to the user through a dynamic object 114 on a landing page associated with the particular video game. For instance, the dynamic object 114 may include an advertisement associated with the manufacturer of the identified item and through which the user may access a website associated with the manufacturer to purchase the identified item. As another example, the dynamic object 114 may include an advertisement associated with another retailer through which the identified item is made available for purchase.

As yet another illustrative example, if a social media platform provides an option to generate a gift object for a particular recipient, and the user selects this option, the intent signal object generation service 102 may automatically detect an intent signal corresponding the user's request to generate a gift object for the particular recipient. For instance, if the user, through the social media platform, selects an option to generate a gift object corresponding to a particular gift object category, the intent signal object generation service 102 may identify an available object placement corresponding to a landing page for selection of a gift object from the particular gift object category and, according to the intent signal, identify a set of assets corresponding to one or more items within the particular gift object category that may be presented to the user through a dynamic object 114 according to the available object placement. This object placement may be prominently located within the landing page such that a user navigating to the landing page through the social media platform may more readily view the dynamic object 114 compared to other items that may be associated with the selected gift object category. The dynamic object 114, according to this example, may include an advertisement from a manufacturer or brand that may make available the one or more items within the particular gift category. For instance, if the particular gift category is for video games from a particular genre, the advertisement presented may include assets corresponding to video games published by a particular brand that are associated with this particular genre.

In an embodiment, an intent signal can be tied to user actions related to other services or systems associated with the intent signal object generation service 102. For example, the intent signal object generation service 102 may be associated with a financial institution that provides lines of credit to different users and processes transactions associated with these lines of credit. As noted above, the intent signal object generation service 102 may collect clickstream data, search data, purchase data, user profile data, and the like through a cookie associated with a user. This data may include information corresponding to a user's application for a line of credit from a financial institution associated with the intent signal object generation service 102. For instance, through a cookie or other obtained data associated with a user, the intent signal object generation service 102 may identify an intent signal corresponding to the user's application for a new line of credit associated with a particular financial institution. Further, based on this cookie or obtained data, the intent signal object generation service 102 may determine the purpose of the user's application for the new line of credit (e.g., the application is accessed during a pending transaction for certain goods and/or services, the application is accessed in response to a particular promotion, etc.). This identified purpose may be used to further define the detected intent signal for which different object placements may be made available. For instance, if a user accesses an application for a new line of credit from a website through which the user is in the process of completing a transaction for landscaping goods (e.g., mulch, seed, rakes, etc.), and the user does not complete this application, the intent signal object generation service 102 may identify an intent signal corresponding to the user's desire to apply for a line of credit that may be used for the purchase of landscaping goods. Accordingly, the intent signal object generation service 102 may make available to third-party systems 110 different object placement to intent signal pairings corresponding to this intent signal.

When a user accesses another website or other platform that includes an object placement maintained by the intent signal object generation service 102, and the intent signal object generation service 102 detects an intent signal corresponding to the user's prior attempt to apply for a line of credit for a transaction for landscaping goods (as determined through a cookie or other data associated with the user), the intent signal object generation service 102 may identify, for the pairing of this object placement and the identified intent signal, a dynamic object that may be presented through this object placement. For example, this particular pairing may be assigned to a third-party system 110 associated with a company that provides landscaping services within the user's geographic region (e.g., city, county, etc.). The intent signal object generation service 102 may identify any assets corresponding to the promotion of these landscaping services and that may be presented to the user through a dynamic object 114 according to the available object placement on the website or other platform. The dynamic object 114, according to this illustrative example, may include an advertisement from a landscaping company that may make available the aforementioned landscaping services within the user's geographic region. Thus, the resulting dynamic object 114 may be relevant to the user's previous purchase of landscaping goods through application for a new line of credit.

As described in greater detail herein, the intent signal object generation service 102 may make different object placement to intent signal pairings available to third-party systems 110 through a bidding process, whereby a third-party system 110 submitting a winning bid for a particular pairing may be assigned to this pairing. The third-party system 110 may provide any assets corresponding to dynamic objects 114 that may be presented to users through the corresponding object placement in response to the intent signal associated with the pairing. In an embodiment, the intent signal object generation service 102 may automatically categorize or classify different intent signals and third-party systems 110 such that object placement to intent signal pairings corresponding to a particular category or classification are made available only to third-party systems 110 corresponding to this particular category or classification. Returning to the aforementioned example where the intent signal detected by the intent signal object generation service 102 corresponds to a user's prior application for a line of credit for the purchase of landscaping goods, the intent signal object generation service 102, this particular intent signal may be classified as belonging to a “landscaping services” classification. Accordingly, the intent signal object generation service 102 may limit bidding for object placement to intent signal pairings corresponding to this intent signal to third-party systems 110 classified as also belonging to the “landscaping services” classification. This may increase the likelihood of the resulting dynamic objects 114 presented to the user for this particular intent signal are relevant or at least ancillary to the detected intent signal.

In some instances, rather than providing a dynamic object 114 corresponding to one or more items within the particular gift object category, the intent signal object generation service 102 may provide a dynamic object 114 that includes one or more items associated with a particular third-party system 110 that is assigned to the particular object placement to intent signal pairing and that are ancillary or otherwise complement the items associated with the selected gift object category. Returning to the aforementioned example, where the particular gift category selected by the user is for video games from a particular genre, the intent signal object generation service 102 may identify an available object placement corresponding to the landing page for selection of a gift object from the particular gift object category. However, this particular object placement and corresponding intent signal may be assigned to a third-party system 110 that provides ancillary products corresponding to the gift object category (e.g., accessories, products, and/or other items often used in conjunction with items corresponding to the selected gift object category, etc.). For example, the dynamic object 114 presented on this landing page may include an advertisement from a beverage company that sells different products that are frequently purchased by gamers who play the types of games represented in the selected gift object category. As another illustrative example, the dynamic object 114 presented on this landing page may include an advertisement from a manufacturer of headsets that features one or more headsets that may be used in conjunction with a console corresponding to the video games represented in the selected gift object category and that are often used within this genre of video games.

An intent signal may further correspond to user requests to redeem a gift from a gifting distribution system or other system that may present users with various gift options according to different gift categories. For example, if a user accesses a website associated with the gifting distribution system to redeem a gift corresponding to a particular gift category, the intent signal object generation service 102 may automatically detect an intent signal corresponding to a user request to redeem a gift corresponding to this particular gift category. For the particular website and the gift category, the intent signal object generation service 102 may maintain one or more object placements through which dynamic objects 114 may be presented to the user when redeeming a gift corresponding to the particular gift category. Accordingly, when a user accesses the particular website to redeem a gift corresponding to a particular gift category, the intent signal object generation service 102 may automatically, and in real-time, identify a set of assets corresponding to one or more items associated with the particular gift category that may be presented to the user through a dynamic object 114 according to any available object placements on the particular website. The one or more items, through the object placement, may be presented prominently on the website such that these one or more items are featured to the user, which may increase the likelihood of the user selecting as their gift any of the one or more items. For example, if the user selects a gift category corresponding to personal audio headsets for redemption of their gift, the intent signal object generation service 102 may automatically generate an advertisement within the object placement corresponding to different headsets that may be made available by a particular manufacturer or brand. Through this advertisement, these headsets associated with the particular manufacturer or brand may be featured more prominently compared to other portable audio headsets presented through the website.

It should be noted that while the aforementioned examples of intent signals are used extensively throughout the present disclosure for the purpose of illustration, other intent signals may be contemplated and may be used to generate different dynamic objects 114 (e.g., advertisements, calls to action, etc.) according to available object placements and the detected intent signals. For example, in some instances, intent signals may correspond to one or more contextual signals that may be used to generate dynamic objects that are tied to these contextual signals. These contextual signals may be user-specific, whereby dynamic objects may be generated based on known or obtained information corresponding to the user to which the dynamic objects are to be presented. For example, through a cookie implemented on a user's computing device, the intent signal object generation service 102 may obtain data about the user that may be used to dynamically generate a dynamic object 114 that is tailored or customized to the user. Through the cookie, the intent signal object generation service 102 may collect clickstream data, search data, purchase data, user profile data, and the like. This contemporaneous data may be aggregated with historical data corresponding to users to which dynamic objects are presented. For instance, over time, the intent signal object generation service 102 may collect data from a user (such as through the cookie, a browser extension, other applications, etc.) and define a user profile for the particular user that may be used as intent signals for determining how dynamic objects 114 may be presented to the user. Thus, in such instances, intent signals may be user-specific and/or may correspond to different types/classes of users (e.g., users belonging to a particular demographic, users located within a particular geographic region, etc.).

In an embodiment, the intent signal object generation service 102, through the cookie associated with a particular user, can automatically and in real-time determine when a previously detected intent signal has ceased. Returning to the illustrative example where a user is presented with a dynamic object 114 corresponding to a call-to-action for purchasing a Mother's Day gift for a special someone associated with the user, the intent signal object generation service 102, through the cookie (and collected clickstream data, search data, purchase data, user profile data, etc.), may detect when the user has engaged with the call-to-action and has completed a purchase of a Mother's Day gift. Accordingly, the intent signal object generation service 102 may automatically determine that the previously detected intent signal associated with the user is concluded. This may result in the intent signal object generation service 102 evaluating the data associated with the cookie to detect any other intent signals that may be used to generate new dynamic objects corresponding to these other intent signals.

In an embodiment, the intent signal object generation service 102 makes available different object placements (e.g., locations or placements within websites, application interfaces, and other interfaces through which advertisements and calls to action may be presented) maintained by the intent signal object generation service 102 for use in presenting different dynamic objects 114 (e.g., advertisements, calls to action, etc.) according to detected intent signals. For instance, the intent signal object generation service 102 may maintain relationships with one or more entities (e.g., retailers, online marketplaces, e-commerce platforms, gift distribution services, etc.) through which the intent signal object generation service 102 may maintain different object placements through which these one or more entities may allow the intent signal object generation service 102 to automatically generate and present dynamic objects in conjunction with other assets and content associated with these one or more entities. For example, the intent signal object generation service 102 may maintain a relationship with a particular retailer system that may maintain websites corresponding to different items made available by the retailer system for purchase. Through these websites, the intent signal object generation service 102 may maintain a set of object placements through which dynamic objects 114 may be presented to users accessing these websites according to any detected intent signals. As another illustrative example, the intent signal object generation service 102 may maintain a relationship with other entities that provide other forms of content (e.g., news agencies, gaming journalism entities, electronic mail providers, search engines, etc.) and that may surface different object placements on their websites through which dynamic objects 114 may be presented. As users navigate to these websites, the intent signal object generation service 102 may detect any intent signals associated with these users and the websites to determine which dynamic objects 114 are to be presented to these users through the available object placements.

The available object placements may be categorized by the intent signal object generation service 102 according to different intent signals that may be detectable and used to determine what dynamic objects 114 may be presented to users. For example, while the intent signal object generation service 102 may maintain a particular object placement for a particular website associated with another entity, this particular object placement may be made available to different entities according to the detected intent signal. As an illustrative example, the intent signal object generation service 102 may make available an object placement for which dynamic objects may be presented for intent signals corresponding to a particular holiday. At the same time, the intent signal object generation service 102 may make available the same object placement but for dynamic objects that may be presented for intent signals corresponding to different user-specific contexts (e.g., different user demographics, different user locations, etc.). In some instances, the intent signal object generation service 102 may further make available the same object placement for which dynamic objects may be presented for combinations of intent signals detected by the intent signal object generation service 102 (e.g., a particular holiday and for users within a particular geographic region, users within a particular geographic region and for requests to generate a gift for a recipient, etc.). Thus, an object placement may be assigned to one entity for a particular set of intent signals while the same object placement may be assigned to a different entity for a different set of intent signals simultaneously.

In an embodiment, the intent signal object generation service 102 implements an object placement request processor 104 that automatically processes requests from third-party systems 110 (e.g., retailers, brands, publishers, online marketplaces, e-commerce platforms, etc.) to assign available object placements to these third-party systems 110 such that dynamic objects associated with these third-party systems 110 may be presented through the assigned object placements. The object placement request processor 104 may be implemented as an application or other executable process on a computing system or other system (e.g., server, special-purpose computer system etc.) of the intent signal object generation service 102. The object placement request processor 104, in response to a request from a particular third-party system 110, may query an object datastore 108 to identify any available object placements for different intent signals and/or combinations of intent signals and in which dynamic objects may be presented to users. For instance, if a third-party system 110 submits a request to identify any object placements that may be available through websites associated with one or more entities (e.g., news agencies, online retailers, online marketplaces, gaming journalism entities, etc.), the object placement request processor 104 may query the object datastore 108 to identify the object placements associated with these one or more entities. Further, from the identified object placements, the object placement request processor 104 may automatically determine which of these identified object placements may be available to the third-party system 110. For instance, the object placement request processor 104 may identify any object placement to intent signal pairings that may be available to third-party systems 110 for presenting different dynamic objects to users. As noted above, an object placement may be assigned to one entity for a particular set of intent signals while the same object placement may be assigned to a different entity for a different set of intent signals simultaneously. Thus, while particular object placements may be assigned to other third-party systems 110 for a set of intent signals, these particular object placements may be available to third-party systems 110 for other intent signals.

In an embodiment, the object placement request processor 104 implements a machine learning algorithm or artificial intelligence that is dynamically trained, in real-time, to generate recommendations for different object placements and corresponding intent signals that may be offered to different third-party systems 110. The machine learning algorithm or artificial intelligence implemented by the object placement request processor 104 may be dynamically trained in real-time using supervised training techniques. For instance, the machine learning algorithm or artificial intelligence may be trained using sample object placements, sample intent signals, sample dynamic objects presented through the sample object placements, and feedback corresponding to user engagement with the sample dynamic objects. The sample intent signals may include user data that may be obtained via cookies (e.g., clickstream data, search data, purchase data, user profile data, etc.), data corresponding to content presented on a website or application (e.g., dates, product details, images, videos, other objects, comments, news stories and headlines, etc.), data obtained from electronic mail messages or social media posts/comments, and the like. The sample intent signals may further include the type or category of website accessed through which the sample object placements are made available. The sample dynamic objects may correspond to different entities, such as different third-party systems 110 (actual and/or hypothetical) that may offer different items or types/categories of items.

The feedback used to dynamically train the machine learning algorithm or artificial intelligence may include any data corresponding to user engagement with the sample dynamic objects presented according to the detected sample intent signal. For instance, the feedback may include statistical information corresponding to the frequency in which sample users interacted with dynamic objects according to detected intent signals. Thus, the statistical information may provide an indication of the efficacy of presented dynamic objects in enticing users to interact with the dynamic objects. In some instances, the feedback may also include external data that may be used to gauge the efficacy of the presented dynamic objects. For instance, for a given dynamic object presented through an object placement and corresponding to one or more intent signals, a third-party system 110 may provide any data corresponding to user engagement with the dynamic object (e.g., purchasing items associated with the dynamic object, accessing websites associated with the third-party system 110 as a result of the dynamic object, etc.). This external data may be further used to determine the efficacy of a dynamic object for particular intent signals.

As an illustrative example of the training of the machine learning algorithm or artificial intelligence, an evaluator of the machine learning algorithm or artificial intelligence (e.g., an administrator of the intent signal object generation service 102, an independent party introduced to perform such evaluations, etc.) may review the recommendations generated by the machine learning algorithm or artificial intelligence to determine whether these recommendations accurately correspond to dynamic objects for particular object placements and intent signals that have a high probability or likelihood of enticing users to interact with the dynamic objects. For example, the evaluator may determine whether a recommendation provided for obtaining an assignment for particular object placements and corresponding intent signals comport with a likelihood of users interacting with dynamic objects that are associated with a requesting entity (e.g., a third-party system 110, etc.) within the particular object placements for these intent signals. As an illustrative example, if an intent signal corresponds to Mother's Day and the object placement corresponds to a call-to-action (CTA) associated with a gifting distribution system through which users may generate gifts for intended recipients, and the recommendation generated by the machine learning algorithm or artificial intelligence corresponds to a third-party system that provides items that are not often associated with Mother's Day gifting, the evaluator of the machine learning algorithm or artificial intelligence may determine that the provided recommendation was not accurate for this third-party system. Based on this feedback, the machine learning algorithm or artificial intelligence may be re-trained to provide accurate or improved recommendations that may be presented to third-party systems 110 in response to their requests to have their dynamic objects presented within different object placements for different intent signals.

In an embodiment, to dynamically train the machine learning algorithm or artificial intelligence used to generate recommendations for different object placements and corresponding intent signals that may be offered to different third-party systems 110, the object placement request processor 104 generates an initial iteration of the machine learning algorithm or artificial intelligence. For instance, the object placement request processor 104 may initialize a set of coefficients {α1, α2, α3, . . . αn} randomly according to a Gaussian distribution with low variance centered around zero. Using this initial iteration of the machine learning algorithm or artificial intelligence, the object placement request processor 104 may process the dataset of sample object placements, sample intent signals, sample dynamic objects presented through the sample object placements, and feedback corresponding to user engagement with the sample dynamic objects to generate an output. This output may specify, for each data point of the dataset, a recommendation corresponding to different object placements and corresponding intent signals that may be offered to a sample third-party system based on any known characteristics of the sample third-party system (e.g., intent signals available to the third-party system, etc.). The object placement request processor 104 may compare this output generated using the initial iteration of the machine learning algorithm or artificial intelligence to the sample recommendations and corresponding feedback included in the dataset for each of the data points (e.g., sample intent signals, sample object placements, sample recommendations, etc.) to identify any inaccuracies or other errors.

If the output of the machine learning algorithm or artificial intelligence does not satisfy one or more criteria, the object placement request processor 104 may iteratively update one or more coefficients of the set of coefficients to generate an updated machine learning algorithm or artificial intelligence. For instance, the one or more criteria may include a threshold for the accuracy of the desired machine learning algorithm or artificial intelligence for generating different recommendations for different intent signals and object placements that may be presented to a third-party system according to the characteristics of the third-party system. The updated machine learning algorithm or artificial intelligence may be used to process the aforementioned training dataset, as well as any additional data points or other datasets provided by the intent signal object generation service 102 or other entity to generate a new output for each data point in the training dataset. In some instances, the object placement request processor 104 may use an optimization algorithm to iteratively update the one or more coefficients of the set of coefficients associated with the machine learning algorithm or artificial intelligence. For instance, the object placement request processor 104 may use gradient descent to update the logistic coefficients of the machine learning algorithm or artificial intelligence to generate new values that may be used to generate new recommendations corresponding to the data points of the previously evaluated dataset and of any new data points obtained by the object placement request processor 104. The object placement request processor 104 may use this updated machine learning algorithm or artificial intelligence to process the available data points and generate a new output. The object placement request processor 104 may evaluate this new output to determine whether the output satisfies the one or more criteria. This process of updating the set of coefficients associated with the machine learning algorithm or artificial intelligence according to the one or more criteria may be performed iteratively until an updated machine learning algorithm or artificial intelligence is produced that satisfies the one or more criteria.

In an embodiment, if the output generated by the machine learning algorithm or artificial intelligence satisfies the one or more criteria, the object placement request processor 104 implements the machine learning algorithm or artificial intelligence to dynamically, and in real-time, process any third-party system requests to assign available object placements to these third-party systems 110 such that dynamic objects associated with these third-party systems 110 may be presented through the assigned object placements. In an embodiment, the object placement request processor 104 uses new feedback including any data corresponding to user engagement with the new dynamic objects presented within different object placements according to detected intent signals to further retrain or otherwise update the machine learning algorithm or artificial intelligence. As noted above, this feedback may include statistical information corresponding to the frequency in which users interact with dynamic objects according to the detected intent signals. Further, in some instances, the feedback may also include external data that may be used to gauge the efficacy of the presented dynamic objects (e.g., users purchasing items associated with the dynamic object, users accessing websites associated with a third-party system 110 as a result of the dynamic object, etc.). This external data may be further used to determine the efficacy of a dynamic object for particular intent signals.

As the machine learning algorithm or artificial intelligence generates, in real-time or near real-time, outputs corresponding to different recommendations for different object placement and intent signal pairings for different third-party systems 110, the object placement request processor 104 or other evaluator of the machine learning algorithm or artificial intelligence may evaluate the output to determine whether the recommendations generated by the machine learning algorithm or artificial intelligence comport with any identified characteristics associated with the different third-party systems 110. This evaluation may result in additional annotated data points that may be used to retrain or otherwise update the machine learning algorithm or artificial intelligence in real-time or near real-time. For instance, if the machine learning algorithm or artificial intelligence generates a recommendation corresponding to a set of object placements for a set of particular intent signals, and the resulting dynamic objects presented through these object placements for the particular intent signals results in negative feedback (e.g., lack of user engagement with the dynamic objects, heightened levels of dismissal of the dynamic objects, etc.), the recommendation may be annotated to indicate that the machine learning algorithm or artificial intelligence has generated a recommendation that did not result in positive user engagement with dynamic objects provided by the corresponding third-party system through the object placements and for the designated intent signals. These annotated data points may be added to the training dataset, which may be used to dynamically retrain or otherwise update the machine learning algorithm or artificial intelligence using the process described above.

In response to a request from a third-party system 110 for one or more object placements through which the third-party system 110 may provide users with different dynamic objects 114 according to different intent signals, the object placement request processor 104 may automatically process the request using the aforementioned machine learning algorithm or artificial intelligence to identify any available object placements and corresponding intent signals that may allow for greater user engagement with these different dynamic objects 114. These recommendations may be provided to the third-party system 110, which may review the provided recommendations to determine whether to request the recommended object placements for the corresponding intent signals identified through the machine learning algorithm or artificial intelligence. The third-party system 110 may provide feedback with regard to these provided recommendations, which may be used to dynamically update the machine learning algorithm or artificial intelligence. For instance, if the third-party system 110 adheres to any of the provided recommendations (e.g., the third-party system 110 selects one or more object placements and corresponding intent signals from the provided recommendations), the object placement request processor 104 may use this adherence to the provided recommendations as positive feedback that may be used to reinforce the machine learning algorithm or artificial intelligence such that, for similar third-party systems 110, similar recommendations may be more likely to be generated. Alternatively, if the third-party system 110 foregoes the provided recommendations and instead selects alternative object placements and/or intent signals for their dynamic objects, the object placement request processor 104 may use this as negative feedback that may be used to retrain the machine learning algorithm or artificial intelligence such that, for similar third-party systems 110, the likelihood of similar recommendations being provided is reduced.

In an embodiment, any available object placements corresponding to different intent signals may be assigned according to a bidding process, whereby different third-party systems 110 may submit resource bids (e.g., bids defined fiat currency amounts, cryptocurrency amounts, etc.) for these available object placements to the object placement request processor 104. Bidding for these available object placements corresponding to different intent signals may be made available for a limited period of time, after which the object placement request processor 104 may process any received bids and assign these available object placements to the third-party system that submitted the highest resource bid. For example, an object placement within a website corresponding to a news agency may be available for intent signals corresponding to an upcoming holiday (e.g., Flag Day, etc.), whereby if the website is accessed within a time window leading up to the upcoming holiday, a dynamic object 114 associated with these intent signals may be presented through the object placement. Accordingly, the object placement request processor 104 may make this object placement and corresponding intent signal available for bidding up to a period of time prior to this time window. Further, the assignment of the object placement may be for a limited time (e.g., until the end of the upcoming holiday, until the end of a period of time after the holiday, etc.). As another illustrative example, an object placement within a website associated with a gifting distribution system may be associated with an intent signal corresponding to user selection of a particular gift category. Accordingly, the object placement request processor 104 may make this object placement and corresponding intent signal available for bidding for a period of time, after which a pairing of the object placement and the intent signal may be assigned to a third-party system. Similar to the earlier example corresponding to an object placement tied to an upcoming holiday, this object placement may be assigned to a third-party system for a limited period of time, after which the object placement and intent signal pairing may be made available for new bids.

In an embodiment, the intent signal object generation service 102 can limit the bidding process for particular object placement to intent signal pairings to designated third-party systems 110 such that only these designated third-party systems 110 may submit resource bids for these pairings. As an illustrative example, the intent signal object generation service 102 may reserve a pairing of an object placement within a website corresponding to a particular medical condition and an intent signal corresponding to user queries to understand more about the particular medical condition for third-party systems 110 associated with organizations that provide support for this particular medical condition. These organizations may include charitable organizations associated with the particular medical condition, manufacturers of pharmaceuticals for addressing the particular medical condition, medical service providers that provide support for this particular medical condition, and the like. As another illustrative example, the intent signal object generation service 102 may reserve a pairing of an object placement within a news website corresponding to a recent natural disaster and an intent signal corresponding to queries to learn more about the natural disaster for third-party systems 110 associated with relief organizations whose missions involve providing aid and relief for such natural disasters.

In an embodiment, the object placement request processor 104 implements a machine learning algorithm or artificial intelligence that is dynamically trained in real-time to automatically categorize and reserve different object placement to intent signal pairings for different types of third-party systems 110. Returning to an aforementioned illustrative example, if the intent signal object generation service 102 makes available a pairing of an object placement within a website corresponding to a particular medical condition and an intent signal corresponding to user queries to understand more about the particular medical condition, the machine learning algorithm or artificial intelligence implemented by the object placement request processor 104 may automatically identify one or more third-party systems 110 to which this pairing may be made available (e.g., charitable organizations associated with the medical condition, medical service providers, pharmaceutical manufacturers, etc.). The machine learning algorithm or artificial intelligence may automatically, and in real-time, process this pairing along with identifying information corresponding to the different third-party systems 110 associated with the intent signal object generation service 102 to automatically identify the one or more third-party systems 110 to which this pairing may be made available for bidding. Based on this output from the machine learning algorithm or artificial intelligence, the object placement request processor 104 may automatically update an entry in the object datastore 108 and corresponding to the particular object placement to intent signal pairing to indicate which third-party systems 110 are authorized to submit bids for the pairing.

The machine learning algorithm or artificial intelligence implemented by the object placement request processor 104 may be dynamically trained in real-time using supervised training techniques. For instance, the machine learning algorithm or artificial intelligence may be trained using sample object placement to intent signal pairings, identifying information associated with sample third-party systems, and feedback provided with regard to sample third-party systems selected for bidding on the sample pairings. In some instances, the machine learning algorithm or artificial intelligence may be further trained using feedback provided with regard to dynamic objects generated for the pairing by sample third-party systems selected for bidding on the sample pairings. As an illustrative example of the training of the machine learning algorithm or artificial intelligence implemented by the object placement request processor 104, an evaluator of the machine learning algorithm or artificial intelligence may review the third-party system selections made by the machine learning algorithm or artificial intelligence based on the input pairings and identifying information associated with these third-party systems to determine whether the selections made by the machine learning algorithm or artificial intelligence correspond to the pairing and the provided identifying information.

As an illustrative example of the training of the machine learning algorithm or artificial intelligence, if an object placement to intent signal pairing corresponds to a particular medical condition for which users may be interested in learning more about the medical condition (e.g., the object placement is located on a website tied to the medical condition, the intent signal corresponds to user queries related to the medical condition, etc.), the evaluator may determine whether the machine learning algorithm or artificial intelligence has selected third-party systems 110 associated with different organizations or other entities that are relevant to this particular medical condition. For example, if the machine learning algorithm or artificial intelligence selects a third-party system 110 associated with a video game publisher for this particular pairing, the evaluator may determine that the machine learning algorithm or artificial intelligence has failed to accurately identify the third-party systems 110 that should be authorized to bid on this particular pairing. As another illustrative example, if the evaluator determines that a dynamic object generated for the pairing corresponds to an advertisement for an online marketplace for clothing, the evaluator may determine that the machine learning algorithm or artificial intelligence has failed to accurately identify the third-party systems 110 that should have been authorized to bid on this particular pairing. Based on this feedback, the machine learning algorithm or artificial intelligence may be re-trained and/or reinforced to provide accurate or improved selections that can be used to reserve different object placement to intent signal pairings for authorized third-party systems 110.

Similar to the training of the machine learning algorithm or artificial intelligence above for generation of object placement and intent signal recommendations, the object placement request processor 104 may dynamically generate an initial iteration of this machine learning algorithm or artificial intelligence for categorizing and reserving different object placement to intent signal pairings for different types of third-party systems 110 according to any of the methods described above. If the output of the machine learning algorithm or artificial intelligence does not satisfy one or more criteria, the object placement request processor 104 may iteratively update one or more coefficients of the set of coefficients to generate new iterations of the machine learning algorithm or artificial intelligence that may be continuously evaluated until an updated machine learning algorithm or artificial intelligence is generated that satisfied the one or more criteria. Once a machine learning algorithm or artificial intelligence is successfully trained according to the one or more criteria, the machine learning algorithm or artificial intelligence may be implemented to categorize and reserve different object placement to intent signal pairings for different third-party systems 110 and/or third-party system types.

In some instances, certain object placement to intent signals may be assigned through an alternative process whereby resource bids may not need to be submitted for pairing assignments. For example, pairings corresponding object placements within websites associated with recent natural disasters (e.g., news articles, etc.) and intent signals corresponding to queries related to these recent natural disasters may be reserved for charitable organizations that provide relief and/or aid to those impacted by these types of natural disasters. These charitable organizations may not be required to submit bids for these pairings. Instead, a charitable organization may be assigned to a particular pairing according to one or more criteria. For instance, a charitable organization may automatically be assigned to a particular pairing based on an evaluation of prior charitable giving by the organization for similar intents for which the pairing is being made available. For example, if a charitable organization has previously provided a threshold amount aid to hurricane victims, the object placement request processor 104 may automatically assign an object placement to intent signal pairing corresponding to a recent hurricane to this charitable organization. In some instances, if there are multiple charitable organizations that provide relief and/or aid for similar issues, the object placement request processor 104 may automatically distribute the available pairings corresponding to these similar issues to these multiple charitable organizations on an equitable basis (e.g., for five charitable organizations and twenty available pairings, the object placement request processor 104 may assign four pairings to each charitable organization, etc.).

In an embodiment, the object placement request processor 104 automatically evaluates any received bids corresponding to a set of object placements associated with one or more intent signals at the end of a bidding cycle to determine the highest obtained bid. Based on the highest obtained bid, the object placement request processor 104 may transmit a request to the third-party system 110 associated with the highest obtained bid to indicate that the third-party system 110 has submitted the highest obtained bid. Further, the object placement request processor 104 may automatically prompt the third-party system 110 to provide any assets corresponding to the set of dynamic objects 114 that are to be presented through the corresponding object placements in response to an associated intent signal. These assets may include images, videos, text, or any other data that may be presented through a dynamic object 114 implemented through object placements provided by the intent signal object generation service 102. In some instances, the assets may further include programmatic code and/or scripts (e.g., JavaScript, HyperText Markup Language (HTML), Cascading Style Sheets (CSS), or any other available web development or programming language) that may be executed through a dynamic object 114 implemented through the aforementioned object placements.

In an embodiment, the object placement request processor 104 enables a third-party system 110 associated with the highest obtained bid to designate another entity that may be permitted to implement a dynamic object 114 for the object placement and intent signal pairing. For instance, a third-party system 110 may wish to donate an object placement for particular intent signals to a charitable organization to allow this charitable organization to solicit donations from users accessing the network object, such as website 112. Accordingly, in response to the prompt from the object placement request processor 104 to provide any assets corresponding to the set of dynamic objects 114 that are to be presented through the corresponding object placements in response to an associated intent signal, the third-party system 110 may provide identifying information associated with the other entity. The identifying information may include the other entity's name, electronic mail address, network address, and the like. Using this identifying information, the object placement request processor 104 may automatically prompt this other entity to provide any assets that may be used to generate one or more dynamic objects 114 through the object placement in response to the associated intent signal. In some instances, the third-party system 110 may alternatively provide a set of assets associated with this other entity that may be used to generate the one or more dynamic objects 114 on behalf of this other entity.

The object placement request processor 104 automatically stores any obtained assets from the third-party system 110 and associated with the assigned object placement-intent signal pairings in the object datastore 108. The object datastore 108 may maintain individual entries corresponding to different object placement-intent signal pairings, through which the object placement request processor 104 may update the entry to include an identifier corresponding to the third-party system 110 to which the pairing is assigned. Further, the object placement request processor 104 may update this entry to associate the pairing with the assets provided by the third-party system 110. In some instances, the entry corresponding to a particular object placement-intent signal pairing may further indicate an expiration date for the association between the pairing and the third-party system 110 that submitted the highest bid for the assignment. Once the association has expired (according to the indicated expiration date), the entry may be automatically updated to remove the association between the pairing and the third-party system 110. This may allow the object placement request processor 104 to automatically determine, in real-time, which object placement-intent signal pairings are available for assignment and bidding.

As illustrated in FIG. 1, the intent signal object generation service 102 further includes an object generation module 106, which may be implemented to dynamically detect access to an object placement on a website, an application, or other network object. For example, when a user navigates to a particular website (e.g., website 112 as illustrated in FIG. 1), the web server associated with the website may automatically execute any available scripts or other programmatic code that is used to generate and present the particular website. In an embodiment, for each object placement that is maintained by the intent signal object generation service 102, the intent signal object generation service 102 may implement a script or other programmatic code that, when executed by the web server, may cause the web server to present a dynamic object 114 within the object placement. Further, through this script or other programmatic code, the intent signal object generation service 102 may expose one or more application programming interfaces (APIs), which the web server may use to transmit data corresponding to the website and to the user accessing the website to the intent signal object generation service 102. For instance, through these one or more APIs, the web server may transmit data corresponding to the various elements presented on the website (e.g., data objects presented on the website, information presented on the website, etc.), as well as the characteristics of the website (e.g., identifying information corresponding to the owner of the website, information indicating the purpose of the website, etc.).

In some instances, the web server or other system that implements the website 112, application, or other network object through which one or more object placements associated with the intent signal object generation service 102 are provided may use a cookie associated with the user accessing the website 112, application, or other network object to obtain data about the user that may be used to select the dynamic objects 114 to be presented within the one or more object placements. Through the cookie, the object generation module 106 may obtain clickstream data (e.g., data corresponding to webpages the user has accessed), search data (e.g., search terms submitted by the user through a search engine, etc.), purchase data (e.g., purchase histories from one or more online retailers, etc.), user profile data (e.g., user profiles from social networking websites, user profiles from multimedia website, etc.), and the like. This data, along with the data provided by the web server or other system corresponding to the website 112, application, or other network object, may be used to detect any relevant intent signals. As an illustrative example, if the user submits, via a search engine, the search terms “best gifts for Mother's Day,” the object generation module 106 may utilize this search data to detect an intent signal corresponding to the user's interested in obtaining a gift for a recipient in anticipation of Mother's Day. Further, the object generation module 106 may identify one or more object placements within the website 112 corresponding to the search engine results provided by the search engine through which dynamic objects 114 may be presented. Accordingly, the object generation module 106 may automatically, and in real-time, query the object datastore 108 to determine whether the one or more object placements have been assigned to a particular third-party system 110 for the detected intent signal (e.g., interest in obtaining a gift for a recipient for Mother's Day).

As another illustrative example, when a user accesses a website or application associated with a gifting distribution system to obtain a gift corresponding to a particular gift category for an intended recipient, the gifting distribution system, through the aforementioned APIs, may transmit data corresponding to the user's access to the website or application, including the particular gift category selected by the user or otherwise presented to the user through the website or application. Accordingly, the object generation module 106 may use data to automatically, and in real-time, detect an intent signal corresponding to a user request to obtain a gift for an intended recipient for the selected or otherwise presented gift category. Accordingly, the object generation module 106 may automatically, and in real-time, query the object datastore 108 to determine, for any object placements associated with the website or application through which gift options are presented to the user for the particular gift category, what dynamic objects 114 are to be provided through these object placements. For example, if a user selects, from the gifting distribution system, a gift category corresponding to video games, the gifting distribution system may transmit, through the one or more APIs, data corresponding to the user's request to review gifting options for video games. Further, the gifting distribution system, through the one or more APIs, may transmit data corresponding to the object placements that are available through the interface provided to the user for presenting available gift options corresponding to the video games gift category. Accordingly, the object generation module 106 may query the object datastore 108 to determine whether the identified object placements, for an intent signal corresponding to a request to obtain a gift within the video games gift category, are assigned to a particular third-party system 110.

In some instances, if a user selects, from the gifting distribution system, a gift category corresponding to a particular type of product (e.g., video games, etc.), the object generation module 106 may use this selection, as well as other information corresponding to the user (as obtained through a cookie, clickstream data, search data, purchase data, etc.), to detect an intent signal corresponding to the user's desire to purchase a gift corresponding to this gift category for a particular recipient. However, the intent signal may further provide an indication that the user does not know or is unaware of common ancillary items or products that are usually obtained in addition to gifts from the selected gift category. For example, if the user selects a gift category corresponding to multiplayer online battle arena (MOBA) video games, for which players commonly communicate with one another through the use of headsets or other multimedia devices, and the object generation module 106 determines, based on the obtained data corresponding to the user, that the user is unfamiliar with MOBA video games and the subculture related to these games, the object generation module 106 may detect an intent signal corresponding to an unfamiliar user's desire to purchase a MOBA video game for a particular recipient. Accordingly, the object generation module 106 may query the object datastore 108 to determine whether the object placements, for this intent signal, are assigned to a particular third-party system 110. This third-party system 110 may be a provider of common accessories related to gaming (e.g., headsets, microphones, etc.) and that may be conducive to better gamer experiences within MOBA environments. Thus, in some instances, when a user selects, from the gifting distribution system, a gift category corresponding to MOBA video games, the user may be presented, through an available object placement, a dynamic object 114 corresponding to a headset that may be purchased alongside a MOBA video game.

As yet another illustrative example, when a user accesses a website or application associated with a gifting distribution system to redeem a gift provided by another user, the gifting distribution system, through the one or more APIs, may transmit data corresponding to the user's request to redeem their gift. The data may include any known parameters associated with the gift (e.g., gift category associated with the gift, value of the gift, etc.) as well as any identifying information associated with the user (e.g., username, demographic information, etc.). In some instances, as the user navigates through the gifting distribution system to redeem their gift, the gifting distribution system may further provide, through the one or more APIs, data corresponding to the user's actions (e.g., selection of a particular gift category, selection of a particular object associated with a gift category, etc.). This data, in addition to the known parameters associated with the gift and any identifying information associated with the user may be used to detect an intent signal usable to identify the dynamic objects 114 that may be presented to the user through available object placements associated with the website or application that the user is interfacing with.

If the object generation module 106 determines that an object placement associated with the website or application that a user is interacting with is assigned to a particular third-party system 110, the object generation module 106 may identify the assets corresponding to the dynamic object 114 that is to be presented through the object placement. For example, as illustrated in FIG. 1, based on an intent signal corresponding to a user's access to a news website 112, the object generation module 106 may determine that the object placement made available through the news website 112 is associated with a third-party system 110 that provides personal audio equipment for purchase. Accordingly, the object generation module 106 may obtain, from the object datastore 108, any available assets associated with the third-party system 110 that may be used to automatically construct a dynamic object 114 that is used to promote the third-party system 110 and one or more items that may be offered by the third-party system 110 to users. These assets may include images, videos, text, or any other data that may be presented through a dynamic object 114. For example, as illustrated in FIG. 1, the dynamic object 114 may include an image of an item offered by the third-party system 110, text that provides a CTA to the user (e.g., “Looking for a Gift?”), and an interface button that may be selected to access a website or application associated with the third-party system 110 for obtaining the presented item.

In an embodiment, the object generation module 106 implements a machine learning algorithm or artificial intelligence that is dynamically trained, in real-time, to process any user-specific intent signals to determine what dynamic object 114 is to be presented through an available object placement in response to the intent signal. For instance, if the intent signal detected by the object generation module 106 corresponds a user accessing a gift distribution system to redeem a gift, where the gift is associated with a particular gift category, and the gift distribution system has provided, through the one or more APIs, identifying information associated with the user, the object generation module 106, through the machine learning algorithm or artificial intelligence, may process the identifying information, data corresponding to the gift category associated with the gift, and data corresponding to the object placement to dynamically, and in real-time, tailor a dynamic object 114 for the user and according to any assignment of the object placement to a third-party system 110 for the intent signal (e.g., requests to redeem a gift associated with a particular gift category).

The machine learning algorithm or artificial intelligence implemented by the object generation module 106 may be dynamically trained in real-time using supervised training techniques. For instance, the machine learning algorithm or artificial intelligence may be trained using sample intent signals, user-specific information (e.g., clickstream data, search data, purchase data, user profile data, user demographic information, etc.), and feedback provided with regard to dynamic objects generated based on the sample intent signals and user-specific information. As an illustrative example of the training of the machine learning algorithm or artificial intelligence implemented by the object generation module 106, an evaluator of the machine learning algorithm or artificial intelligence (e.g., an administrator of the intent signal object generation service 102, independent party introduced to perform such evaluations, etc.) may review the dynamic objects generated by the machine learning algorithm or artificial intelligence to determine whether these dynamic objects correspond to the detected intent signal and comport with the user-specific information.

As an illustrative example, if an intent signal corresponds to a user's request to redeem a gift tied to a video games gift category, and the user-specific information associated with this user denotes a preference for Japanese-style role-playing games, the evaluator may determine whether the resulting dynamic object presented to the user corresponds to the third-party system assigned to the pairing of the intent signal and the object placement through which the dynamic object is being presented (e.g., the dynamic object is associated with a video game publisher that is assigned to the object placement and the intent signal corresponding to the user's request to redeem a gift tied to a video games gift category). Further, the evaluator may determine whether the dynamic object includes assets that are personalized according to the user's preference for Japanese style role-playing games provided by the identified video game publisher. For instance, if the resulting dynamic object includes assets corresponding to the incorrect third-party system (e.g., a different video game publisher, an entity associated with a different category of items entirely, etc.), the evaluator may determine that the machine learning algorithm or artificial intelligence has failed to accurately detect the appropriate intent signal for generating the dynamic object. As another example, if the resulting dynamic object includes assets corresponding to the correct third-party system but otherwise includes assets that do not correspond to the user-specific information (e.g., the dynamic object includes assets corresponding to first-person shooters rather than Japanese-style role-playing games, etc.), the evaluator may determine that the machine learning algorithm or artificial intelligence has failed to accurately process the user-specific information to generate a dynamic object tailored to the user's preferences. Otherwise, if the evaluator determines that the resulting dynamic object does include assets corresponding to the correct third-party system and that these assets do comport with the user-specific information (e.g., the dynamic object includes images, text, etc. associated with Japanese-style role-playing games made available by the correct video game publisher), the evaluator may determine that the machine learning algorithm or artificial intelligence is producing accurate results. Based on this feedback, the machine learning algorithm or artificial intelligence may be re-trained and/or reinforced to provide accurate or improved dynamic objects that can be presented to users.

Similar to the training of the machine learning algorithm or artificial intelligence above for generation of object placement and intent signal recommendations, object generation module 106 may dynamically generate an initial iteration of this machine learning algorithm or artificial intelligence for processing any user-specific intent signals to determine what dynamic object 114 is to be presented through an available object placement in response to the intent signal according to any of the methods described above. If the output of the machine learning algorithm or artificial intelligence does not satisfy one or more criteria, the object generation module 106 may iteratively update one or more coefficients of the set of coefficients to generate new iterations of the machine learning algorithm or artificial intelligence that may be continuously evaluated until an updated machine learning algorithm or artificial intelligence is generated that satisfied the one or more criteria. Once a machine learning algorithm or artificial intelligence is successfully trained according to the one or more criteria, the machine learning algorithm or artificial intelligence may be implemented to process, in real-time any newly detected user-specific intent signals to determine what dynamic object 114 is to be presented through an available object placement.

In an embodiment, the object generation module 106 monitors, in real-time, user interaction with provided dynamic objects 114 to dynamically generate data corresponding to user engagement with these dynamic objects 114. As noted above, the object placement request processor 104 may implement and dynamically train, in real-time, a machine learning algorithm or artificial intelligence for generating recommendations for different object placements and corresponding intent signals that may be offered to different third-party systems 110. This machine learning algorithm or artificial intelligence, as described above, may be dynamically trained in real-time using feedback including statistical information corresponding to the frequency in which users interacted with dynamic objects according to detected intent signals. The object generation module 106, through its monitoring in real-time of user interactions with the provided dynamic objects 114, may automatically generate this statistical information. For example, for a particular dynamic object 114 presented through an object placement and generated by the object generation module 106 for different users based on their corresponding intent signals, the object generation module 106 may dynamically and in real-time aggregate data corresponding to interactions by these different users with the dynamic object 114. This data may be aggregated by the object generation module 106 according to the corresponding object placement to intent signal pairings. Through this aggregation of data, the frequency in which users interacted with different dynamic objects according to the object placements and detected intent signals can be determined. As noted above, this statistical data information may provide an indication of the efficacy of presented dynamic objects in enticing users to interact with the dynamic objects.

Thus, as users interact with different dynamic objects 114 presented through different object placements and in response to different intent signals associated with these users, the object placement request processor 104 and the object generation module 106 may update their respective machine learning algorithms or artificial intelligence in real-time. For example, as the object generation module 106 monitors user interactions with different dynamic objects 114 presented through different object placements and for different intent signals, the object generation module 106 may continuously and constantly update the machine learning algorithm or artificial intelligence implemented and dynamically trained to generate tailored dynamic objects 114 according to user-specific intent signals upon detection. Further, as the object generation module 106 updates any statistical information corresponding to the presentation of, and interaction with, different dynamic objects 114, the object placement request processor 104 may continuously and constantly update the machine learning algorithm or artificial intelligence implemented and dynamically trained to generate recommendations for different object placement to intent signal pairings that may be of interest to different third-party systems 110.

It should be noted that the aforementioned machine learning algorithms or artificial intelligence are dynamically trained, in real-time, as different dynamic objects 114 are generated for different object placements and according to different intent signals as these different intent signals are detected. These machine learning algorithms or artificial intelligence may simultaneously, and continuously, provide recommendations to third-party systems 110 and dynamically generate user-specific dynamic objects 114 according to any detected intent signals. Further, as these recommendations are provided and the user-specific dynamic objects 114 are generated for different intent signals, any feedback received corresponding to these myriad recommendations and myriad user-specific dynamic objects 114 may be used to dynamically, and in real-time, re-train or otherwise update these machine learning algorithms or artificial intelligence. This allows for the machine learning algorithms or artificial intelligence to constantly generate recommendations and tailored dynamic objects 114 for different third-party systems 110 and users, respectively, as requests from these third-party systems 110 are received and as different users interact with different dynamic objects 114 according to different intent signals and the corresponding multitude of available object placements provided through myriad websites, applications, and other network locations. Further, this allows for the machine learning algorithms or artificial intelligence to be constantly updated in real-time based on feedback corresponding to provided recommendations and dynamic objects 114, as new requests from third-party systems 110 are received, and as dynamic objects 114 are generated according to newly detected intent signals and interacted with by different users.

As noted above, an assignment of a particular object placement to intent signal pairing to a third-party system 110 may be subject to an expiration date, as indicated in the object placement to intent signal pairing entry maintained in the object datastore 108. In an embodiment, the object placement request processor 104 automatically detects an expiration of an existing object placement to intent signal pairing and accordingly makes this pairing available to the third-party systems 110 for bidding. In some instances, prior to making the pairing available for bidding, the object placement request processor 104 may transmit a notification to the third-party system 110 previously assigned to the pairing to offer the third-party system 110 an opportunity to renew their assignment to the pairing. The notification may indicate the amount of resources previously allocated by the third-party system 110 in their winning bid for the pairing. This may allow the third-party system 110 to determine whether to again allocate the same amount of resource to the pairing for a new assignment period. If the third-party system 110 determines that they wish to maintain the assignment of the expired pairing to the third-party system 110, the third-party system 110 may transmit the amount of resources to the object placement request processor 104, which may update the entry corresponding to this pairing to record the assignment and to indicate a new expiration date for the assignment. However, if the third-party system 110 opts to reject the opportunity to renew their object placement to intent signal pairing assignment, the object placement request processor 104 may update the entry corresponding to this pairing to make the pairing available to any third-party system 110 according to the aforementioned bidding process.

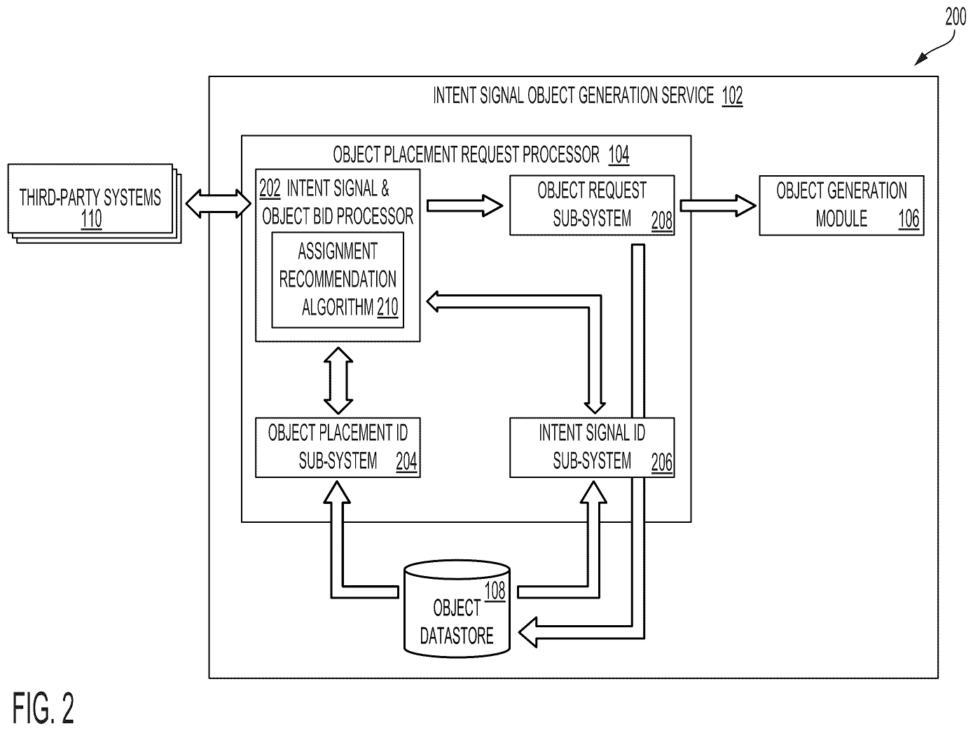

FIG. 2 shows an illustrative example of an environment 200 in which an object placement request processor 104 automatically and in real-time processes incoming bids for different object placements corresponding to different intent signals to assign sets of assets for the different object placements in accordance with at least one embodiment. In the environment 200, the object placement request processor 104 implemented by the intent signal object generation service 102 may include an intent signal and object bid processor 202 that is dynamically configured to process incoming requests to assign object placements to different third-party systems 110. The intent signal and object bid processor 202 may be implemented as an application or other executable process on a computer system or other system (e.g., server, virtual machine instance, special-purpose computing device, etc.) of the intent signal object generation service 102. In an embodiment, the intent signal and object bid processor 202 automatically, and in real-time, processes incoming bids for different object placement to intent signal pairings such that, for a winning bid, the intent signal and object bid processor 202 may assign a particular object placement to intent signal pairing to a third-party system 110 that submitted the winning bid.

In an embodiment, the intent signal and object bid processor 202 provides, to third-party systems 110 accessing the intent signal object generation service 102, an interface (such as a graphical user interface (GUI)) through which these third-party systems 110 may identify any available object placement to intent signal pairings. For instance, when a third-party system 110 accesses the intent signal object generation service 102 to evaluate any available object placement to intent signal pairings that may be open for bidding, the intent signal and object bid processor 202 may identify these available pairings. To identify these available pairings, the object placement request processor 104 may query an intent signal identification sub-system 206 implemented by the object placement request processor 104 to determine which intent signals are detectable by the intent signal object generation service 102. As noted above, an intent signal intent signal may include any data obtained by the intent signal object generation service 102 based on content presented to users through websites, applications, or other user interfaces. For example, intent signals may correspond to user data that may be obtained via cookies (e.g., clickstream data, search data, purchase data, user profile data, etc.), data corresponding to content presented on a website or application (e.g., dates, product details, images, videos, other objects, comments, news stories and headlines, etc.), data obtained from electronic mail messages or social media posts/comments, and the like. The intent signals may further include the type or category of website accessed through which different object placements are made available. Further, the intent signals may include any actions performed by users through these websites, applications, or other user interfaces (e.g., clicking on an interface button corresponding to a selection of an item category, navigation through a provided interface for a threshold period of time, completing a checkout process, etc.).

The available intent signals may be maintained by the intent signal object generation service 102 based on prior data corresponding to user interactions with the websites, applications, or other user interfaces through which dynamic objects may be presented to users. For instance, the intent signal object generation service 102 may establish a relationship with a particular entity that implements a website, through which the intent signal object generation service 102 may provide different dynamic objects according to allocated object placements on the website. These dynamic objects may be presented to users accessing the website. In some instances, this particular entity may provide the intent signal object generation service 102 with data corresponding to actions that may be performable on the website. Further, the entity may provide the intent signal object generation service 102 with data corresponding to actions performed by users to access the website (e.g., selection of a dynamic object from another website, executing an application that re-directs the user to the website, etc.). This data may be used by the intent signal identification sub-system 206 to dynamically identify the various intent signals that may cause a user to access the website and corresponding object placements through which dynamic objects may be presented to the user. The intent signal identification sub-system 206 may be implemented as an application or other executable process on a computer system or other system (e.g., server, virtual machine instance, special-purpose computing device, etc.) of the intent signal object generation service 102.

In an embodiment, the intent signal identification sub-system 206 may generate, within the object datastore 108, entries corresponding to the different intent signals for which dynamic objects may be generated. Further, the intent signal identification sub-system 206 may tie each entry corresponding to an intent signal to any of the object placements maintained by the intent signal object generation service 102 through which dynamic objects associated with the intent signal may be presented. For example, while the intent signal object generation service 102 may maintain various object placements across different websites, applications, or other user interfaces, these various object placements may not be associated with the same set of intent signals. As an illustrative example, an object placement made available through a website catering to vegan products may not be associated with intent signals corresponding to user queries for hunting-related items or for meat-related items. As another illustrative example, an object placement made available through a gift distribution service platform may be uniquely tied to intent signals corresponding to user requests for generating a gift for intended recipients and to intent signals corresponding to selections made within the platform.

When a third-party system 110 accesses the intent signal and object bid processor 202, such as through the aforementioned interface provided by the intent signal and object bid processor 202, the intent signal and object bid processor 202 may query the intent signal identification sub-system 206 to identify the myriad intent signals that are detectable by the intent signal object generation service 102 when users access different websites, applications, or other user interfaces through which the intent signal object generation service 102 may maintain different object placements for presentation of different dynamic objects. For instance, if the intent signal and object bid processor 202 detects that a third-party system 110 has accessed the intent signal object generation service 102, the intent signal and object bid processor 202 may automatically, and in real-time, query the intent signal identification sub-system 206 to identify the intent signals that are detectable by the intent signal object generation service 102. In response to this query, the intent signal identification sub-system 206 may access the object datastore 108 to identify the entries corresponding to the different intent signals detectable by the intent signal object generation service 102. From these entries, the intent signal identification sub-system 206 may return, to the intent signal and object bid processor 202, identifiers corresponding to the different intent signals detectable by the intent signal object generation service 102.

The intent signal and object bid processor 202, through the interface provided to the third-party systems 110, may present a listing or other ordering of the intent signals that are detectable by the intent signal object generation service 102. Through the interface, a third-party system 110 may determine which intent signals that the third-party system 110 may be interested in for providing dynamic objects to users in response to these intent signals. As an illustrative example, if a third-party system 110 provides Christmas-related items to users, the third-party system 110 may be interested in intent signals corresponding to the Christmas holiday, intent signals corresponding to requests to obtain a gift for an intended recipient, and the like. As another illustrative example, if a third-party system 110 is associated with a video game publisher that publishes Japanese-style role playing games for different gaming platforms, the third-party system 110 may be interested in intent signals corresponding to user selection of any video games belonging to the Japanese-style role playing genre from any website, intent signals corresponding to user selection of any of the different gaming platforms supported by the third-party system 110, intent signals corresponding to requests to obtain a gift for an intended recipient that is interested in video games, and the like. Thus, based on the audience that a third-party system 110 would like to reach through their dynamic objects, the third-party system 110, through the provided interface, may select one or more different intent signals that, if detected, may trigger presentation of these dynamic objects to users.

In addition to providing a listing or other ordering of the available intent signals, the intent signal and object bid processor 202 may further provide, through the interface, a listing or ordering of available object placements through which dynamic objects may be presented to users. As noted above, object placements may allow for the creation and presentation of dynamic objects that may allow users to perform one or more actions associated with the third-party systems 110 assigned to these object placements. For example, the intent signal object generation service 102 may maintain one or more available object placements corresponding to different platforms through which dynamic objects may be presented through these available object placements. As an illustrative example, an available object placement may correspond to a portion of a website that is visible to a user accessing the website. This particular object placement may allow for the presentation of a dynamic object that may prominently highlight a set of assets corresponding to the third-party system 110 that may be appealing to users based on detected intent signals. Further, the dynamic object may include a CTA that may entice users to interact with the dynamic object.

To identify the object placements available for presentation of dynamic objects for different intent signals, the intent signal and object bid processor 202 may query an object placement identification sub-system 204 implemented by the object placement request processor 104. The object placement identification sub-system 204 may be implemented as an application or other executable process on a computer system or other system (e.g., server, virtual machine instance, special-purpose computing device, etc.) of the intent signal object generation service 102. In response to this query, the object placement identification sub-system 204 may access the object datastore 108 to identify any available object placements through which dynamic objects may be presented for different intent signals. The object datastore 108 may maintain, for each object placement associated with the intent signal object generation service 102, an entry that may be used to denote assignments of the object placement to different third-party systems 110 for different intent signals. For example, an entry corresponding to a particular object placement may include a unique identifier corresponding to the object placement, a description of where the object placement is made available (e.g., a portion of a particular website, a banner on an application interface associated with a particular application, etc.), the dimensions of the object placement, and the like. Further, in an embodiment, the entry can indicate the intent signals that the object placement is associated with. For instance, an entry corresponding to a particular object placement may indicate the different intent signals that have been previously associated with the object placement (such as through previous assignments, etc.) or that are otherwise available for pairing with the object placement.

In an embodiment, an entry corresponding to a particular object placement may further indicate any current assignments according to different intent signals. For example, for a set of intent signals, the object placement may be assigned to a particular third-party system 110 such that, upon detection of an intent signal from the set of intent signals through a website, application, or other network location where the object placement is present, a dynamic object associated with the particular third-party system 110 may be generated and presented to users. The entry corresponding to a particular object placement may indicate, for an assigned object placement to intent signal pairing specified in the entry, a unique identifier corresponding to the third-party system 110 assigned to the pairing, as well as information corresponding to the assets usable to generate the dynamic object (e.g., network locations for retrieval of these assets, identifiers corresponding to these assets, executable instructions for generating the dynamic object from these assets, etc.) and an expiration date/time for the present assignment.

In some instances, the query submitted by the intent signal and object bid processor 202 to the object placement identification sub-system 204 may indicate any intent signals selected by a third-party system 110 through the interface provided by the intent signal and object bid processor 202. Using these indicated intent signals, the object placement identification sub-system 204 may access the object datastore 108 to identify any object placements that may be available for the indicated intent signals. For instance, if an object placement is currently assigned to another third-party system 110 for an indicated intent signal, the object placement identification sub-system 204 may forego providing information corresponding to this object placement to the intent signal and object bid processor 202. However, if an object placement is not assigned to another third-party system 110 for an indicated intent signal, the object placement identification sub-system 204 may indicate, for the object placement, information corresponding to the object placement and an indication of which intent signals the object placement is available for from the indicated set of intent signals. The intent signal and object bid processor 202 may update the interface to provide the third-party system 110 with information corresponding to any available object placements for the indicated intent signals.

In an embodiment, the intent signal and object bid processor implements an assignment recommendation algorithm 210 that is dynamically trained in real-time to generate and provide recommendations for different object placements and intent signals that may be on interest to different third-party systems 110. The assignment recommendation algorithm 210 may be trained using supervised training techniques. For instance, the assignment recommendation algorithm 210 may be trained using sample object placements, sample intent signals, sample dynamic objects presented through the sample object placements, and feedback corresponding to user engagement with the sample dynamic objects. The sample intent signals may include user data that may be obtained via cookies (e.g., clickstream data, search data, purchase data, user profile data, etc.), data corresponding to content presented on a website or application (e.g., dates, product details, images, videos, other objects, comments, news stories and headlines, etc.), data obtained from electronic mail messages or social media posts/comments, and the like. The sample intent signals may further include the type or category of website accessed through which the sample object placements are made available. As noted above, sample dynamic objects may correspond to different entities that may provide CTAs or other elements that may serve to entice users to interact with the dynamic objects.

In some instances, the feedback used by the intent signal and object bid processor 202 to dynamically update the assignment recommendation algorithm 210 in real-time may include any data corresponding to user engagement with the sample data objects presented according to a detected sample intent signal. For instance, this feedback may include statistical information corresponding to the frequency in which sample users interacted with presented dynamic objects according to the intent signals associated with these sample users. Using this statistical information, the intent signal and object bid processor 202 may determine the efficacy of presented dynamic objects in enticing users to interact with these dynamic objects. In some instances, the feedback may also include data from the third-party systems 110 that may be used to gauge the efficacy of any presented dynamic objects. For instance, for a given dynamic object presented through an object placement and corresponding to one or more intent signals, a third-party system 110 may provide any data corresponding to user engagement with the dynamic object. The intent signal and object bid processor 202 may use this external data to determine the efficacy of a dynamic object for different intent signals.

An evaluator of the assignment recommendation algorithm 210 (e.g., the intent signal and object bid processor 202, an independent evaluator associated with the intent signal and object bid processor 202, etc.) may review the recommendations generated by the assignment recommendation algorithm 210 to determine whether these recommendations accurately correspond to particular object placements and intent signals that would allow a third-party system 110 to present dynamic objects that are likely to entice users to interact with these dynamic objects. For example, the evaluator may determine whether a recommendation provided to a third-party system 110 for possible assignments of different particular object placements and corresponding intent signals comport with a likelihood of users interacting with dynamic objects associated with the third-party system 110 and presentable within the particular object placements in response to these intent signals. Based on this feedback, the assignment recommendation algorithm 210 may be updated to improve the likelihood of the assignment recommendation algorithm 210 providing accurate recommendations that may be presented to third-party systems 110 in response to their requests to have their dynamic objects presented within different object placements for different intent signals.

In an embodiment, when a third-party system 110 accesses the intent signal object generation service 102 and submits a request to the intent signal and object bid processor 202 to identify any available object placements for different intent signals, the intent signal and object bid processor can process the request using the assignment recommendation algorithm 210 to dynamically provide the third-party system 110 with one or more recommendations corresponding to different object placement to intent signal pairings that may be appealing to the third-party system 110 or that are otherwise predicted to drive engagement with dynamic objects associated with the third-party system 110. The intent signal and object bid processor 202 may provide these recommendations to the third-party system 110 through the aforementioned interface provided by the intent signal and object bid processor 202. Through this interface, a third-party system 110 may review the provided recommendations to determine whether to request the recommended object placements for the corresponding intent signals identified by the assignment recommendation algorithm 210.

In some instances, in response to a provided recommendation corresponding to different object placements and intent signals that may be used to generate and present dynamic objects associated with a third-party system 110, the third-party system 110 may provide feedback with regard the recommendation. This feedback provided by the third-party system 110 may be used to dynamically update the assignment recommendation algorithm 210. For instance, if the third-party system 110 adheres to any of the provided recommendations (e.g., the third-party system 110 selects one or more object placements and corresponding intent signals from the provided recommendations), the intent signal and object bid processor 202 may use this selection as an indication that the third-party system 110 has accepted the provided recommendations. Accordingly, the intent signal and object bid processor 202 may use this selection as positive feedback that may be used to reinforce the assignment recommendation algorithm 210 such that, for similar third-party systems 110, the assignment recommendation algorithm 210 may be more likely to generate similar recommendations. Alternatively, if the third-party system 110 foregoes the provided recommendations and instead selects alternative object placements and/or intent signals for their dynamic objects, the intent signal and object bid processor 202 may use this as negative feedback that may be used to retrain the assignment recommendation algorithm 210 such that, for similar third-party systems 110, the likelihood of the assignment recommendation algorithm 210 generating similar recommendations is reduced.

It should be noted that assignment recommendation algorithm 210 is dynamically trained, in real-time, as different dynamic objects are generated for different object placements and according to different intent signals as these different intent signals are detected. The assignment recommendation algorithm 210 may simultaneously, and continuously, provide recommendations to third-party systems 110. Further, as these recommendations are provided, any feedback received corresponding to these myriad recommendations may be used to dynamically, and in real-time, re-train or otherwise update the assignment recommendation algorithm 210. This allows for the assignment recommendation algorithm 210 to constantly generate recommendations for different third-party systems 110, as requests from these third-party systems 110 are received. Further, this allows for the assignment recommendation algorithm 210 to be constantly updated in real-time based on feedback corresponding to provided recommendations and as new requests from third-party systems 110 are received.

In an embodiment, the assignment recommendation algorithm 210 is further dynamically trained in real-time to automatically categorize and reserve different object placement to intent signal pairings for different types of third-party systems 110. For instance, the assignment recommendation algorithm 210 may be trained using sample object placement to intent signal pairings, identifying information associated with sample third-party systems, and feedback provided with regard to sample third-party systems selected for bidding on the sample pairings. The dataset used to train the assignment recommendation algorithm 210 may further include feedback corresponding to dynamic objects generated for the pairing by sample third-party systems selected for bidding on the sample pairings. The evaluator of the assignment recommendation algorithm 210 may review the third-party system selections made by the assignment recommendation algorithm 210 based on the sample inputs (e.g., sample object placement to intent signal pairings and identifying information corresponding to the sample third-party systems) to determine whether the assignment recommendation algorithm 210 is accurately associating different object placement to intent signal pairings to the correct third-party systems 110 or types of third-party systems.

In some instances, when a third-party system 110 accesses the intent signal object generation service 102 and submits a request to the intent signal and object bid processor 202 to identify any available object placements for different intent signals, the intent signal and object bid processor 202 may identify any pairings that are classified as being available to the third-party system 110 and any other pairings that may not be reserved for any particular third-party system or third-party system type. For instance, if the assignment recommendation algorithm 210 has previously associated the third-party system 110 with one or more pairings that may be made available to the third-party system 110 for bidding, the intent signal and object bid processor 202 may automatically provide this particular pairing to the third-party system 110 in response to their request. For any pairings previously associated with the third-party system 110 by the assignment recommendation algorithm 210, the intent signal and object bid processor 202 may monitor the third-party system's interaction with this particular pairing to obtain feedback with regard to the third-party system selections made by the assignment recommendation algorithm 210 for the provided pairing. For example, if the third-party system 110 indicates that a provided pairing selected based on an association between the third-party system 110 and the pairing as defined by the assignment recommendation algorithm 210 is not relevant to the needs of the third-party system 110, the intent signal and object bid processor 202 may determine that the assignment recommendation algorithm 210 has incorrectly associated the third-party system 110 with this particular pairing. This negative feedback may be used to dynamically re-train the assignment recommendation algorithm 210 such that the likelihood of similar third-party systems being associated with this particular pairing is reduced. In some instances, the results provided to the third-party system 110 in response to their request may be added to the dataset used to train the assignment recommendation algorithm 210. This may allow an evaluator to review the selections made by the assignment recommendation algorithm 210 in real-time to determine the accuracy of these selections and, based on this determination, re-train or otherwise update the assignment recommendation algorithm 210.

It should be noted that assignment recommendation algorithm 210 is dynamically trained, in real-time, as different object placement to intent signal pairings are presented to different third-party systems 110 in response to their requests and as bids are submitted for different pairings by these third-party systems 110. The assignment recommendation algorithm 210 may simultaneously, and continuously, provide associate different third-party systems 110 with different pairings according to the identifying information associated with these different third-party systems 110 and the characteristics of these pairings, as described above. Further, as available pairings are provided in response to requests from different third-party systems 110, any feedback received corresponding to the myriad responses to these requests (e.g., bids submitted for presented pairings, dismissal of any presented pairings) may be used to dynamically, and in real-time, re-train or otherwise update the assignment recommendation algorithm 210. This allows for the assignment recommendation algorithm 210 to constantly associate different third-party systems 110 to different pairings in order to make these pairings available according to these associations, as requests from these third-party systems 110 are received. Further, this allows for the assignment recommendation algorithm 210 to be constantly updated in real-time based on feedback corresponding to provided pairings and as new requests from third-party systems 110 are received.

As noted above, any available object placement to intent signal pairings may be available to third-party systems 110 through a bidding process, whereby the intent signal and object bid processor 202 may open these available pairings to bidding for a limited period of time. Once the period of time has elapsed, the intent signal and object bid processor 202 may automatically assign the pairing to the third-party system 110 that submitted the highest bid for this pairing. In an embodiment, for each available object placement to intent signal pairing, the intent signal and object bid processor 202 automatically and in real-time processes any received bids during the limited time window for bidding on the pairing to identify the highest resource bid for the pairing. For instance, the intent signal and object bid processor 202 may automatically evaluate any received bids corresponding to a set of available object placements associated with one or more intent signals at the end of a bidding cycle to determine the highest obtained bid. Based on the highest obtained bid, the intent signal and object bid processor 202 may transmit a notification to the third-party system 110 associated with the highest obtained bid to indicate that the third-party system 110 has submitted the highest obtained bid.

In an embodiment, once the intent signal and object bid processor 202 has identified a winning bid for a particular object placement to intent signal pairing, the intent signal and object bid processor 202 may transmit the request associated with the winning bid to an object request sub-system 208 implemented by the object placement request processor 104. The object request sub-system 208 may be implemented as an application or other executable process on a computer system or other system (e.g., server, virtual machine instance, special-purpose computing device, etc.) of the intent signal object generation service 102. In response to receiving a request for assignment of a particular object placement to intent signal pairing to a third-party system 110 that submitted the winning bid for the pairing, the object request sub-system 208 may access the object datastore 108 to update the entry associated with the object placement to record the assignment. For instance, the object request sub-system 208 may indicate, for the intent signal specified in the object placement entry, that the pairing of this object placement to the intent signal is assigned to the third-party system 110 that submitted the highest bid. Further, the object request sub-system 208 may indicate the expiration date for this assignment, after which the pairing may be made available to other third-party systems 110 through the aforementioned resource bidding process.

In an embodiment, the object request sub-system 208 can prompt the third-party system 110 newly assigned to an object placement to intent signal pairing for any assets that may be used to generate dynamic objects that are presentable through the object placement. For instance, the object request sub-system 208, in response to the request from the intent signal and object bid processor 202, may automatically prompt the third-party system 110 to provide any assets corresponding to the set of dynamic objects that are to be presented through the corresponding object placement in response to the one or more intent signals for which the third-party system 110 submitted a winning bid. As noted above, these assets may include images, videos, text, or any other data that may be presented through a dynamic object implemented through object placements provided by the intent signal object generation service 102. In some instances, the assets may further include programmatic code and/or scripts that may be executed through a dynamic object implemented through the aforementioned object placements. The object request sub-system 208 may automatically store any obtained assets from the third-party system 110 and associated with the assigned object placement to intent signal pairing in the object datastore 108. In response to obtaining the assets that may be used to generate dynamic objects presentable through the object placement to which the third-party system 110 is assigned according to a particular intent signal, the object request sub-system 208 may update the entry corresponding to the object placement to associate these assets with the particular object placement to intent signal pairing assigned to the third-party system 110.

In an embodiment, the object request sub-system 208 may further provide configuration information associated with the one or more dynamic objects that are to be presented through an object placement for one or more intent signals to the object generation module 106. This configuration information may include parameters for presenting the dynamic object associated with the object placement to intent signal pairing upon detection of the intent signal. These parameters may include dimensions associated with the dynamic object, any assets that are to be executed within website, application, or other network object in order to present the dynamic object within the object placement, and the like. In some instances, the object request sub-system 208 may provide, to the object generation module 106, an identifier corresponding to the object placement entry in the object datastore 108, which the object generation module 106 may use to automatically identify the assets that are to be used to generate a dynamic object within an object placement in response to a particular intent signal.

As noted above, an assignment of a particular object placement to intent signal pairing to a third-party system 110 may be subject to an expiration date, as indicated in the object placement entry maintained in the object datastore 108. In an embodiment, the intent signal and object bid processor 202 continuously and in real-time monitors the object datastore 108 to automatically detect an expiration of an existing object placement to intent signal pairing. If an assignment corresponding to a particular pairing has expired, the intent signal and object bid processor 202 may update the object placement entry to remove the assignment of the pairing. Accordingly, the intent signal and object bid processor may make this pairing available to the third-party systems 110 for bidding. In some instances, prior to making the pairing available for bidding, the intent signal and object bid processor 202 may transmit a notification to the third-party system 110 previously assigned to the pairing to offer the third-party system 110 an opportunity to renew their assignment to the pairing. The notification may indicate the amount of resources previously allocated by the third-party system 110 in their winning bid for the pairing. This may allow the third-party system 110 to determine whether to again allocate the same amount of resources to the pairing to obtain the assignment for a new period of time. If the third-party system 110 determines that they wish to maintain the assignment of the expired pairing to the third-party system 110, the third-party system 110 may transmit the amount of resources to the intent signal and object bid processor 202. The intent signal and object bid processor 202 may update the entry corresponding to this object placement to record the assignment and indicate a new expiration date for the assignment. However, if the third-party system 110 opts to reject the opportunity to renew their object placement to intent signal pairing assignment, the intent signal and object bid processor 202 may update the entry corresponding to object placement to make the pairing available to any third-party system 110 according to the aforementioned bidding process.

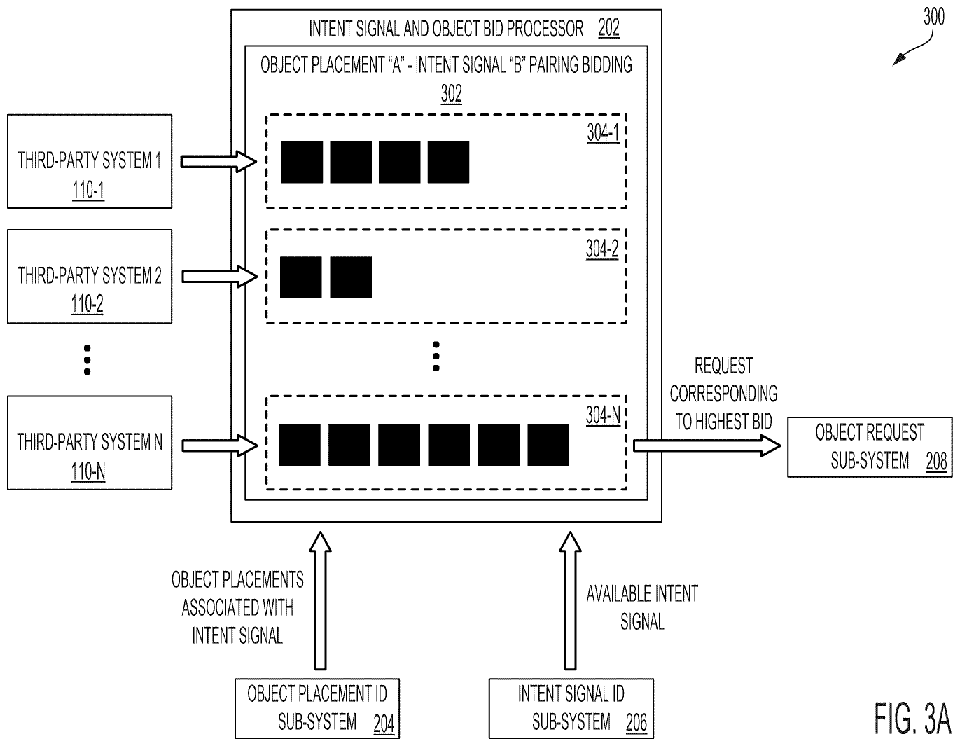

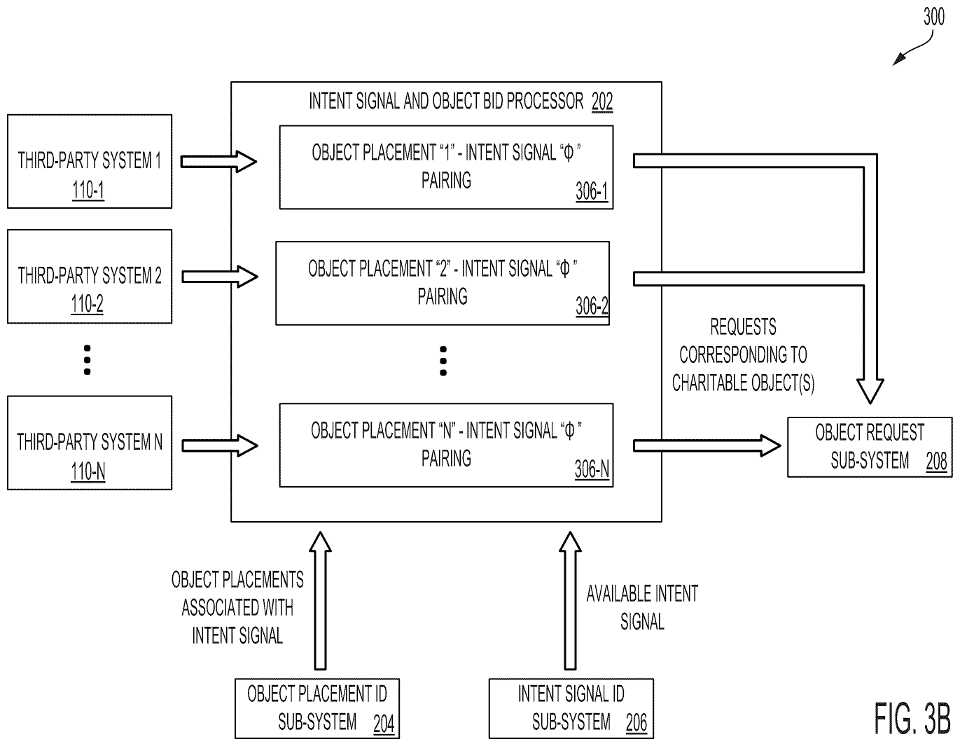

FIGS. 3A-3B show an illustrative example of an environment 300 in which an intent signal and object bid processor 202 automatically and in real-time evaluates bids received from different third-party systems 110-1-110-N for object placements associated with a particular intent signal to determine which assets are to be associated with these object placements in accordance with at least one embodiment. As noted above, the intent signal and object bid processor 202 may open any available object placement to intent signal pairings for bidding, whereby a third-party system that submits the highest bid for a pairing may be permitted to present different dynamic objects through the corresponding object placement and in response to the intent signal associated with the pairing. In the environment 300, and as illustrated in FIG. 3A, an illustrative example of the bidding process 302 for a particular object placement to intent signal pairing (e.g., Object Placement “A”-Intent Signal “B”) that is available for assignment to a third-party system is provided.

In an embodiment, the intent signal and object bid processor 202 automatically queries an intent signal identification sub-system 206 to identify any available intent signals that may be detectable by the intent signal object generation service as users interact with different websites, applications, or other network objects through which the intent signal object generation service maintains different object placements. These available intent signals may be maintained by the intent signal object generation service based on prior data corresponding to user interactions with these websites, applications, or other network objects. The intent signal and object bid processor 202 may present these available intent signals to the different third-party systems 110-1-110-N through an interface provided by the intent signal and object bid processor 202. This may allow the different third-party systems 110-1-110-N to determine which intent signals that the third-party systems 110-1-110-N may be interested in for providing dynamic objects to users in response to these intent signals.

When a third-party system selects an intent signal from the available intent signals indicated through the interface provided by the intent signal and object bid processor 202, the intent signal and object bid processor 202 may query the object placement identification sub-system 204 to identify any available object placements for the selected intent signal. As noted above, the intent signal object generation service may implement an object datastore, which may include entries corresponding to different object placements maintained by the intent signal object generation service and through which different dynamic objects may be presented according to detected intent signals. For instance, an entry within the object datastore and corresponding to a particular object placement may indicate any assignments of the object placement to different third-party systems according to different intent signals. As an illustrative example, an entry corresponding to a particular object placement may denote, for a particular object placement to intent signal pairing, that the pairing is assigned to a particular third-party system. Further, for this assignment, the entry may further specify an expiration date for the assignment, after which the pairing may become newly available for bidding. Thus, based on the selected intent signal, the object placement identification sub-system 204 may evaluate the entries corresponding to the different object placements maintained by the intent signal object generation service to determine which object placements may be available to different third-party systems 110-1-110-N for the selected intent signal. These available object placements may be presented to these third-party systems 110-1-110-N through the aforementioned interface provided by the intent signal and object bid processor 202.

As noted above, an available object placement to intent signal pairing may be assigned to a third-party system according to a bidding process 302, through which the intent signal and object bid processor 202 may automatically process any bids 304-1-304-N as these bids 304-1-304-N are received over a period of time to determine which third-party system may be assigned to the pairing. For instance, when an object placement to intent signal pairing becomes available, the intent signal and object bid processor 202 may establish a bidding process for this pairing for a pre-determined period of time (e.g., a day, a week, etc.) during which bids may be submitted by different third-party systems 110-1-110-N for the pairing. When a third-party system selects an object placement to intent signal pairing that is of interest to the third-party system, the intent signal and object bid processor 202 may provide this third-party system with information corresponding to the bidding process 302 for the pairing. For instance, through the interface provided by the intent signal and object bid processor 202, the intent signal and object bid processor 202 may indicate the amount of time remaining for the bidding process 302 before an assignment is determined based on obtained bids. Additionally, through the interface, the intent signal and object processor 202 may indicate the current highest bid for the pairing. For example, as illustrated in FIG. 3A, third-party system 110-N may have the highest bid 304-N for the pairing compared to other bids 304-1-304-2 submitted by other third-party systems 110-1-110-2. Accordingly, if a third-party system selects this particular pairing, the intent signal and object bid processor 202 may indicate the amount of time remaining for the bidding process 302 and the bid 304-N submitted by the third-party system 110-N.

In some instances, the bidding process 302 for a particular object pairing to intent signal pairing may be subject to one or more criteria that may need to be satisfied before an assignment is granted according to the highest received bid. For example, the intent signal and object bid processor 202 may require, for a particular pairing, a minimum amount of resources in the highest bid in order for the assignment to be granted. For example, for the bidding process 302, the intent signal and object bid processor 202 may establish a reserve resource amount that is required in order for the bidding process 302 to be completed. If this reserve resource amount is not satisfied once the period of time for bidding has elapsed, the intent signal and object bid processor 202 may terminate the bidding process 302 without assigning the pairing to the third-party system that submitted the highest bid during the bidding process 302. Further, the intent signal and object bid processor 202 may again make the pairing available for bidding for a new period of time. As another illustrative example of a possible criterium that may be established for the bidding process 302, the intent signal and object bid processor 202 may require that a minimum number of third-party systems submit bids for the pairing before the bidding process can be completed. The implementation of such a criterium may result in the bidding process 302 not being subject to a time limit after which a winning bid is determined. Alternatively, implementation of such a criterium may result in the bidding process 302 being terminated at the end of the pre-determined time period without an assignment should the number of third-party systems submitting bids for the pairing be less than the minimum number required.

In an embodiment, once the bidding process 302 has concluded for an object placement to intent signal pairing, the intent signal and object bid processor 202 automatically evaluates the bids 304-1-304-N received from the third-party systems 110-1-110-N to identify the highest bid received for the pairing. For example, as illustrated in FIG. 3A, third-party system 110-N has submitted the highest bid 304-N compared to bids 304-1-304-2 submitted by third-party system 110-1 and third-party system 110-2, respectively. Accordingly, the intent signal and object bid processor 202 may evaluate bid 304-N to determine whether this bid 304-N satisfies the applicable criteria, if any, for the bidding process 302. For instance, if the bidding process 302 is subject to a requirement whereby a reserve resource amount is required in order for the pairing to be assigned to a third-party system, the intent signal and object bid processor 202 may determine whether bid 304-N is greater than this reserve resource amount. If the bid 304-N is not greater than the reserve resource amount, the intent signal and object bid processor 202 may determine that the pairing cannot be assigned to third-party system 110-N. Further, the intent signal and object bid processor 202 may restart the bidding process 302 for a new period of time to solicit new bids for the pairing. As another illustrative example, if the intent signal and object bid processor 202 determines at the end of the bidding period for the bidding process 302 that an insufficient number of third-party systems have submitted bids for the pairing, the intent signal and object bid processor 202 may determine that the pairing cannot be assigned to the third-party system 110-N that submitted the highest bid for the pairing.

If the intent signal and object bid processor 202 determines that the highest bid 304-N submitted for the pairing during the bidding process 302 satisfies the applicable set of criteria for the bidding process 302 (if any), the intent signal and object bid processor 202 may transmit the request associated with the highest bid 304-N to the object request sub-system 208. The object request sub-system 208, in response to this request, may update the entry associated with the object placement corresponding to the pairing to indicate that the pairing of this object placement to the intent signal is now assigned to the third-party system 110-N. Additionally, the object request sub-system 208 may indicate, through the entry, an expiration date for this assignment, after which the object placement to intent signal pairing may be made available through a new bidding process facilitated by the intent signal and object bid processor 202. As noted above, the object request sub-system 208 may further prompt the third-party system 110-N newly assigned to this pairing to provide any assets that may be used to generate, in real-time, dynamic objects that may be presented through the object placement in response to the intent signal.

As noted above, in some instances, certain object placement to intent signals may be assigned through alternative processes whereby resource bids, such as resource bids 304-1-304-N may not be required in order to obtain a particular object placement to intent signal assignment. For example, as illustrated in FIG. 3B, the intent signal and object bid processor 202 may make a particular set of object placement to intent signal pairings 306-1-306-N available to different third-party systems 110-1-110-N subject to other criteria. For instance, the intent signal object generation service may designate a particular set of object placement to intent signal pairings, such as pairings 306-1-306-N, as being made available for free to third-party systems that provide charitable services or otherwise provide relief and/or aid to others for different purposes (e.g., natural disaster relief, refugee assistance, homeless services, family assistance for serious illnesses, etc.). In order for a third-party system to qualify for a free object placement to intent signal pairing, the third-party system may be required to satisfy a set of criteria defined by the intent signal object generation service. For instance, a third-party system may be required to have provided an amount of relief or aid that is greater than a pre-defined threshold amount (e.g., a threshold amount of money for aid/relief, a threshold amount of service time in providing aid/relief, etc.). In some instances, a third-party system may be required to provide credentials indicating their status as a charitable organization (e.g., documentation indicating their Internal Revenue Service status as a 501(c)(3) organization, etc.). If the set of criteria is satisfied, a third-party system may be qualified to obtain an assignment for a particular object placement to intent signal pairing without undergoing a bidding process.

As illustrated in FIG. 3B, the third-party systems 110-1-110-N have submitted individual requests to the intent signal and object bid processor 202 to identify any object placement to intent signal pairings that may be available for assignment to these third-party systems 110-1-110-N. In response to these requests, the intent signal and object bid processor 202 may automatically query the intent signal identification sub-system 206 to identify any available intent signals that may be detectable by the intent signal object generation service as users interact with different websites, applications, or other network objects through which the intent signal object generation service maintains different object placements. As noted above, these available intent signals may be maintained by the intent signal object generation service based on prior data corresponding to user interactions with these websites, applications, or other network objects. Similar to the process described above in connection with FIG. 3A, the intent signal and object bid processor 202 may present these available intent signals to the different third-party systems 110-1-110-N through an interface provided by the intent signal and object bid processor 202. Accordingly, each of the different third-party systems 110-1-110-N may be presented with these available intent signals and determine which intent signals these third-party systems 110-1-110-N may be interested in.

In an embodiment, certain intent signals (e.g., intent signal “q”, as illustrated in FIG. 3B) are reserved for third-party systems that provide charitable services or otherwise provide relief and/or aid to others for different purposes. For example, an intent signal corresponding to a user intent to learn more or take action with regard to a natural disaster may be reserved for third-party systems that provide relief or aid services for such natural disasters. As another illustrative example, an intent signal corresponding to a user attempting to learn more about a serious medical condition (e.g., cancer, heart disease, etc.) may be reserved for third-party systems associated with organizations that provide services related to this serious medical condition (e.g., charitable organizations associated with the medical condition, medical service providers, pharmaceutical manufacturers, etc.). As these intent signals may be reserved for certain types of third-party systems, the intent signal and object bid processor 202 may automatically evaluate any received requests to determine whether the corresponding third-party systems qualify for generating dynamic objects for these reserved intent signals. For example, the intent signal and object bid processor 202 may evaluate a submitted request to determine whether the corresponding third-party system has provided any credentials indicating their status as a charitable organization and/or other information that may be used to determine whether the third-party system qualified for being assigned to object placements corresponding to these reserved intent signals (e.g., the third-party system has provided the requisite relief/aid related to the intent signal, etc.). If the third-party system has not provided the requisite credentials and/or other information required to determine their eligibility for these reserved intent signals, the intent signal and object bid processor 202 may forego presenting these reserved intent signals to the third-party system.

In an embodiment, the intent signal reserved for third-party systems that provide charitable services for different purposes can be tied to particular events corresponding to charitable giving. For instance, an intent signal reserved for these third-party systems may be associated with “Giving Tuesday,” the Tuesday after Thanksgiving in the United States during which individuals and organizations are encouraged to donate to charitable causes. This intent signal may be detectable on or within a time range from the actual date of “Giving Tuesday” such that object placement to intent signal pairings corresponding to this intent signal may allow for the presentation of dynamic objects associated with third-party systems to which these pairings are reserved. In some instances, the intent signal object generation service may maintain a limited set of object placement to intent signals pairings for these particular intent signals. For example, the object generation module described above may only attempt to detect this intent signal for particular object placements such that dynamic objects corresponding to this intent signal are only presented through these object placements. Returning to the aforementioned example corresponding to the “Giving Tuesday” intent signal, the object generation module may attempt to detect the “Giving Tuesday” intent signal for object placements made available through retailer websites, gifting applications, social media platforms, and the like. However, for object placements implemented on other network resources for which no object placement to intent signal pairings exist, the object generation module may forego detection of the “Giving Tuesday” intent signal.

In some instances, the intent signal may include a combination of particular events corresponding to charitable giving and user propensity for making donations during these particular events. As noted above, through a cookie, the intent signal object generation service may collect clickstream data, search data, purchase data, user profile data, and the like associated with a particular user. In an embodiment, the intent signal object generation service automatically, and in real-time, processes the collected data through the cookie to determine, in combination with a detected event corresponding to charitable giving, whether the user is associated with an intent to make a charitable donation or otherwise provide a gift corresponding to the detected event. If the intent signal object generation service detects an intent signal corresponding to the particular charitable giving event and the user's own intent to make a charitable donation/gift, the intent signal object generation service may identify, for an available object placement on the network resource accessed by the user, an object placement to intent signal pairing corresponding to this object placement and to this intent signal. If the intent signal object generation service identifies an object placement to intent signal pairing corresponding to this combination of object placement and detected intent signal, the intent signal object generation service may identify the third-party system associated with the pairing and obtain a set of assets associated with the third-party system that may be used to generate a dynamic object that may be presented to the user. This dynamic object may include a solicitation for a donation or gift for the particular event. In some instances, the dynamic object may be customized to include contextual information associated with the particular user based on the data obtained through the aforementioned cookie. For example, the dynamic object may make reference to the user (e.g., the user's name, etc.), the user's past giving (e.g., previous donations, the user's propensity for certain types of donations, etc.), and the like.

In some instances, the intent signal and object bid processor 202 may present any available intent signals to the different third-party systems 110-1-110-N through an interface provided by the intent signal and object bid processor 202 regardless of whether these third-party systems 110-1-110-N qualify for any of the reserved intent signals maintained by the intent signal identification sub-system 206. However, if a third-party system selects, from the interface, a particular reserved intent signal, the intent signal and object bid processor 202 may prompt the third-party system to provide any required credentials or other information that may be used to determine whether the third-party system is eligible to obtain object placement to intent signal pairings for the reserved intent signal. For instance, if a third-party system has selected a reserved intent signal corresponding to a user intent to learn more or take action with regard to a natural disaster, the intent signal and object bid processor 202 may prompt the third-party system to provide their credentials demonstrating that they are associated with a natural disaster relief or aid organization (e.g., documentation indicating their Internal Revenue Service status as a 501(c)(3) organization, etc.). In some instances, if the third-party system has been previously vetted by the intent signal object generation service, the third-party system may be provided with a token (e.g., cryptographic token, etc.) that may be used to verify that the third-party system has been vetted by the intent signal object generation service as being associated with a charitable organization that may be assigned object placement to intent signal pairings corresponding to particular reserved intent signals. Accordingly, the third-party system, in response to the request from the intent signal and object bid processors 202, may provide this token to the intent signal and object bid processor 202. If the third-party system cannot be verified as being eligible for the reserved intent signal, the intent signal and object bid processor 202 may automatically deny the request from the third-party system to identify available pairings corresponding to the reserved intent signal.

In an embodiment, if the third-party system is qualified for a reserved intent signal surfaced by the intent signal and object bid processors 202, the intent signal and object bid processor 202 queries the object placement identification sub-system 204 to identify any available object placements for the selected reserved intent signal. Based on the selected reserved intent signal, the object placement identification sub-system 204 may evaluate the entries corresponding to the different object placements maintained by the intent signal object generation service to determine which object placements may be available to the different third-party systems 110-1-110-N for the selected reserved intent signal. These available object placements may be presented to these third-party systems 110-1-110-N through the aforementioned interface provided by the intent signal and object bid processor 202.

As noted above, any object placement to intent signal pairings corresponding to particular intent signals may be reserved for allocation to qualified third-party systems outside of the bidding process described above. For instance, the intent signal object generation service may designate a particular set of object placement to intent signal pairings, such as pairings 306-1-306-N, as being made available for free to third-party systems that provide charitable services or otherwise provide relief and/or aid to others for different purposes. The pairings 306-1-306-N may be assigned to the third-party systems 110-1-110-N through an alternative process whereby resource bids may not need to be submitted for assignment of a third-party system to a particular pairing corresponding to a reserved intent signal. For example, the intent signal and object bid processor 202 may assign an object placement to intent signal pairing corresponding to a reserved intent signal on a “first come, first served” basis to a requesting third-party system that is authorized to obtain pairings corresponding to the reserved intent. Alternatively, the intent signal and object bid processor 202 may automatically, and proactively, assign the pairings 306-1-306-N to the third-party systems 110-1-110-N known to be authorized to obtain pairings corresponding to the reserved intent. For example, as illustrated in FIG. 3B, third-party system 110-1 may be automatically assigned to object placement to intent signal pairing 306-1 (e.g., object placement “1” to intent signal “q”); third-party system 110-2 may be automatically assigned to object placement to intent signal pairing 306-2 (e.g., object placement “2” to intent signal “q”); and third-party system 110-N may be automatically assigned to object placement to intent signal pairing 306-N (e.g., object placement “N” to intent signal “q”). Each pairing may correspond to the same reserved intent signal “q” but may correspond to different object placements available to the intent signal object generation service.

In some instances, the distribution of available object placement to intent signal pairings 306-1-306-N to the third-party systems 110-1-110-N may be performed automatically by the intent signal and object bid processor 202 on an equitable basis. For example, as illustrated in FIG. 3B, if there is a 1:1 correlation between the number of available object placement to intent signal pairings for the reserved intent signal and the number of third-party systems that qualify for these pairings, the intent signal and object bid processor 202 may automatically assign an available pairing to a corresponding third-party system until each third-party system is assigned a particular pairing for generation of a dynamic object. In some instances, if there are more third-party systems than available pairings corresponding to a reserved intent signal, the intent signal and object bid processor 202 may apply different criteria for determining how to distribute these available pairings to the third-party systems. For instance, the intent signal and object bid processor 202 may automatically assign these available pairings based on an evaluation of prior charitable giving by the organizations associated with the identified third-party systems for similar intents for which the pairings are being made available. The intent signal and object bid processor 202 may accordingly assign the available pairings to the third-party systems whose organizations have historically provided the greatest amount of charitable giving for the particular intent.

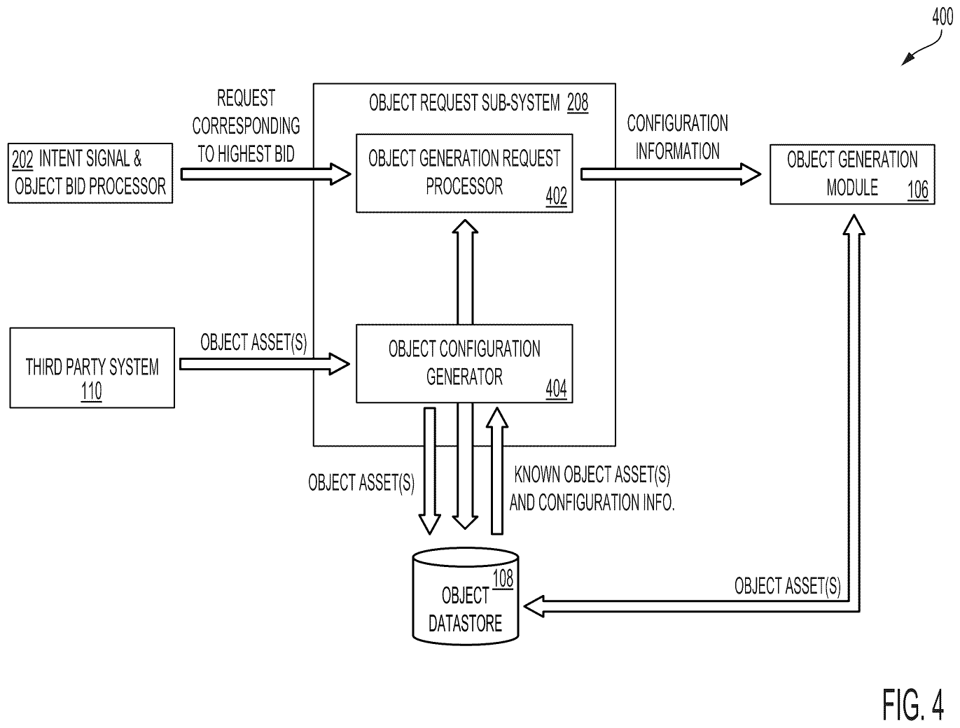

FIG. 4 shows an illustrative example of an environment 400 in which an object request sub-system 208 dynamically provides available assets and configuration information corresponding to objects associated with a particular intent signal for generation of these objects in response to the particular intent signal in accordance with at least one embodiment. As noted above, the intent signal object generation service may implement an object request sub-system 208 that may process incoming requests to assign different object placement to intent signal pairings to different third-party systems based on bids submitted by these third-party systems for these pairings. Further, the object request sub-system 208 may further provide configuration information associated with the one or more dynamic objects that are to be presented through an object placement for one or more intent signals to the object generation module 106. The object generation module 106 may use this configuration information to configure the object placement and to generate the dynamic objects to be presented through the object placement.

In the environment 400, the object request sub-system 208 may include an object generation request processor 402 that may automatically, and in real-time, obtain requests corresponding to the highest bids submitted for different object placement to intent signal pairings as the bidding processes associated with these pairings are completed. The object generation request processor 402 may be implemented as an application or other executable process on a computer system or other system (e.g., server, virtual machine instance, special-purpose computing device, etc.) of the intent signal object generation service. In response to the request obtained from the intent signal and object bid processor 202, the intent signal and object bid processor 202 may access the object datastore 108 to update the entry associated with the object placement corresponding to the pairing to record the assignment of the pairing to the third-party system 110 that submitted the highest bid for the pairing. The updated entry may indicate, for the pairing, the third-party system 110 assigned to the pairing, as well as an expiration date (if applicable) for the assignment, after which the pairing may become newly available for bidding according to the bidding process described above.

In addition to updating the entry corresponding to the object placement associated with the object placement to intent signal pairing, the object generation request processor 402 may transmit a request to an object configuration generator 404 implemented by the object request sub-system 208 to obtain any assets and configuration information that may be used to generate any dynamic objects associated with the third-party system 110 within the object placement associated with the pairing in response to detection of the corresponding intent signal. The object configuration generator 404 may be implemented as an application or other executable process on a computer system or other system (e.g., server, virtual machine instance, special-purpose computing device, etc.) of the intent signal object generation service. The request from the object generation request processor 402 may include an identifier corresponding to the third-party system 110 to which the pairing is assigned. Further, the request may include information corresponding to the object placement to intent signal pairing that has been assigned to the third-party system 110. For instance, the request may include identifiers corresponding to the intent signals selected by the third-party system 110 for placement of their dynamic objects. Further, the request may include identifiers corresponding to the object placement selected by the third-party system 110 (e.g., network location where the object placement is made available, default configuration specifications for the network location (e.g., pixel length and width, compatible programmatic code(s), and the like), etc.).

In some instances, the object placement may be customizable, whereby a third-party system 110 may define the configuration of the object placement to allow for presentation of dynamic objects associated with the third-party system 110. For example, the dimensions of an object placement within a particular website may be customizable up to a pre-defined limit (e.g., a maximum pixel area, a maximum length, a maximum width, etc.). Additionally, or alternatively, a third-party system 110 may define what types of media may be presented through the object placement for their dynamic objects (e.g., digital video formats, digital audio formats, digital image formats, etc.). As another illustrative example, the object placement may be customized to allow for the automatic execution of scripts or other programmatic code when a user accesses a network location (e.g., website, application page, other network object, etc.) that includes the object placement. If the object placement is customizable, the object configuration generator 404 may provide, to the third-party system 110, information regarding the possible customizations that may be made to the object placement, including any limitations on these customizations. This may allow the third-party system 110 to define configurations for the object placement according to different dynamic objects that are to be presented through the object placement.

In response to receiving a set of object assets and configuration information corresponding to the object placement and the dynamic objects that are to be presented through the object placement in response to an assigned intent signal, the object configuration generator 404 may store the object assets and the configuration information within the object datastore 108 or at a different network location associated with the intent signal object generation service that may be implemented to dynamically store dynamic object assets and configuration information for different third-party systems for creation of dynamic objects. Further, the object configuration generator 404 may update the entry corresponding to the object placement to indicate, for the object placement to intent signal pairing, identification and location information corresponding to these object assets and configuration information.

In an embodiment, once the object configuration generator 404 has received the object assets and configuration information for the object placement to intent signal pairing, the object configuration generator 404 may provide configuration information associated with the object placement to the object generator module 106 through the object generation request processor 402. As noted above, the configuration information provided by the object configuration generator 404 may include parameters for presenting the dynamic object associated with the object placement to intent signal pairing upon detection of the intent signal. These parameters may include dimensions associated with the dynamic object, any assets that are to be executed within website, application, or other network object in order to present the dynamic object within the object placement, and the like. If the third-party system 110 did not provide configuration information for the object placement and the dynamic objects that are to be presented within the object placement, the object configuration generator 404 may provide default configuration information associated with the object placement itself.

In some instances, the object configuration generator 404, through the object generation request processor 402, may additionally provide an identifier corresponding to the object placement entry in the object datastore 108. For instance, when the object generation module 106 detects an intent signal corresponding to user actions associated with a website, application, or other network object, the object generation module 106 may identify the object placements present within the website, application, or other network object. Accordingly, using the provided identifier and the detected intent signal, the object generation module 106 may identify, from the object placement entry, the object placement to intent signal pairing. Further, from this pairing, the object generation module 106 may automatically, and in real-time, identify the object assets to be used for generation of a dynamic object associated with the third-party system 110 within the object placement. The object generation module 106 may use the provided configuration information for the object placement and the assets from the object datastore 108 or other network location specified in the object placement entry to dynamically, and in real-time, generate and present the dynamic object within the object placement.

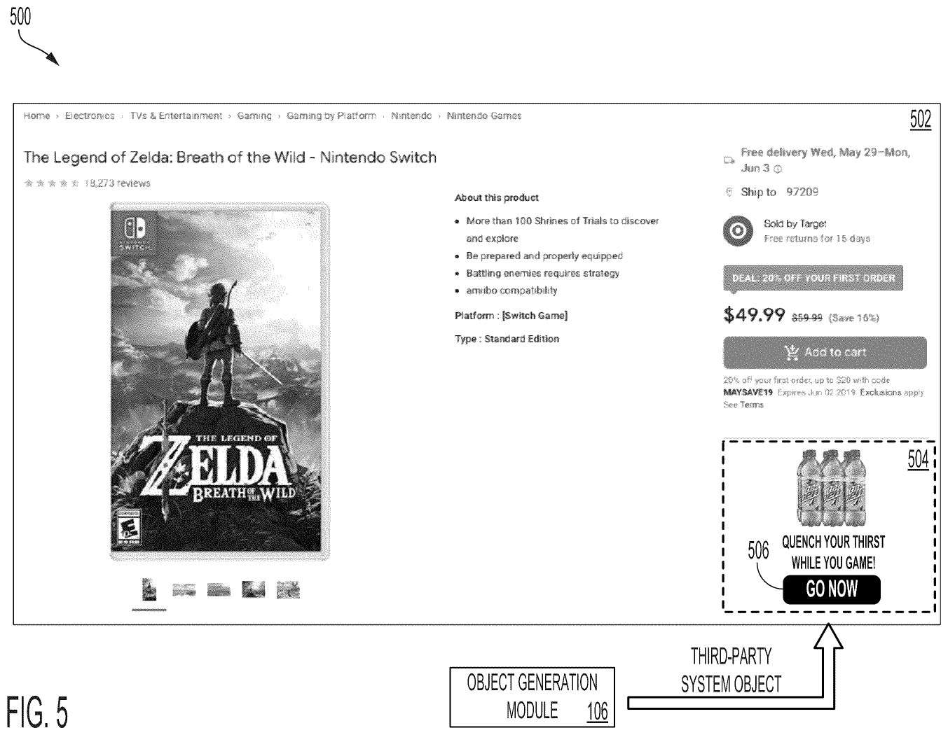

FIG. 5 shows an illustrative example of an environment 500 in which an object generation module 106 dynamically and in real-time generates an object 504 on a landing page 502 using assets associated with a highest bid and in response to a detected intent signal in accordance with at least one embodiment. In the environment 500, a user has used a browser application implemented on their user device to access an online marketplace. For example, as illustrated in FIG. 5, the user has accessed a landing page 502 corresponding to a video game made available for purchase through the online marketplace. The landing page 502 may include detailed information regarding the video game (e.g., a title, the video game platform associated with the video game, a description of the video game plot, a price associated with the video game, images of gameplay corresponding to the video game, etc.).

In an embodiment, the landing page 502 includes an object placement through which the object generation module 106 may generate and present a dynamic object 504 according to an intent signal detected based on user interaction associated with the landing page 502. As noted above, for each object placement that is maintained by the intent signal object generation service, the intent signal object generation service may implement a script or other programmatic code that, when executed by the web server that implements the landing page 502, may cause the web server to present the dynamic object 504 within the object placement. Further, through this script or other programmatic code, the intent signal object generation service may expose one or more APIs, which the web server may use to transmit data corresponding to the landing page 502 and to the user accessing the landing page 502 (as obtained through a cookie or other detected user interactions) to the object generation module 106. For instance, through these one or more APIs, the web server may transmit data corresponding to the various elements presented on the landing of the landing page 502 (e.g., identifying information corresponding to the owner of the online marketplace, information indicating the purpose of the landing page 502, etc.).

In response to the data provided by the web server associated with the landing page 502, the object generation module 106 may automatically, and in real-time, detect any relevant intent signals that may be used to identify the dynamic object 504 that is to be presented through the object placement. As an illustrative example, if the user accessed the landing page 502 in response to submission of the search terms “best role-playing games for the Switch,” the object generation module 106 may utilize this search data, as well as the user's access to the landing page 502, to detect an intent signal corresponding to the user's interest in obtaining the particular video game being presented on the landing page 502. Based on this intent signal and identifying information corresponding to the object placement provided on the landing page 502, the object generation module 106 may query the object datastore to determine whether the pairing of the object placement to this particular intent signal has been assigned to a particular third-party system. If the pairing has not been assigned to a particular third-party system, the object generation module 106 may generate a default dynamic object through the object placement. This default dynamic object may not be tied to any third-party system. Alternatively, the default dynamic object may be generated randomly from a pool of default dynamic objects associated with different third-party systems and/or to the intent signal object generation service 102 itself.

In an embodiment, if the object placement to intent signal pairing is assigned to a particular third-party system, the object generation module 106 may obtain a set of assets corresponding to a dynamic object 504 associated with the third-party system that is to be presented through the object placement on the landing page 502. For instance, from the entry corresponding to the object placement, the object generation module 106 may determine the network location for these assets in order to retrieve these assets for generation of the dynamic object 504. For instance, for the dynamic object 504 illustrated in FIG. 5, the object generation module 106 may obtain assets corresponding to the image presented within the object placement (e.g., an image of a soft drink), text to be presented through the object placement and corresponding to the presented image, and assets that may be used to generate a CTA 506 that allows the user to interact with the dynamic object 504 in order to perform a desired action (e.g., selection of the CTA 506 to redirect the user to a landing page associated with the third-party system, etc.). Using these assets, the object generation module 106 may dynamically generate, in real-time, the dynamic object 504 within the object placement implemented on the landing page 502.

In an embodiment, the object generation module 106 generates, and presents, a user-specific dynamic object 504 through the object placement based on any user-specific intent signals detected by the object generation module 106. As noted above, the object generation module 106 may implement a machine learning algorithm or artificial intelligence that is dynamically trained, in real-time, to process any user-specific intent signals to determine what dynamic object is to be presented through the object placement. For instance, if the web server that implements the landing page 502 provides identifying information corresponding to the user that accessed the landing page 502, the object generation module 106 may process this identifying information along with the intent signal and information corresponding to the object placement through the machine learning algorithm or artificial intelligence to dynamically generate one or more tailored assets that may be included in the dynamic object 504 that may be specific to the user. As an illustrative example, if the object placement to intent signal is assigned to a third-party system that provides different types of soft drinks for purchase, the object generation module 106 may determine, based on the provided user identifying information, any user preferences for one or more particular types of soft drinks provided by the third-party system. Accordingly, the object generation module 106 may obtain any available assets corresponding to these one or more particular types of soft drinks to generate a dynamic object 504 that highlights the user's preferences. Further, the object generation module 106 may customize the accompanying text included in the dynamic object 504 to be user-specific (e.g., referring to the user's name, referring to a physical location close to the user where the user may obtain the promoted items, etc.). Through this personalized customization of the dynamic object 504, the object generation module 106 may further entice the user to interact with the dynamic object 504.

In an embodiment, the object generation module 106 monitors, in real-time, user interaction with the dynamic object 504 to dynamically generate data corresponding to user engagement with the dynamic object 504. For instance, for each impression of the dynamic object 504 on the landing page 502, the object generation module 106 may determine whether a corresponding user engaged with the provided dynamic object 504 (e.g., selected the CTA 506, hovered their cursor over the dynamic object 504 for a period of time, conducted a later search for the product featured in the dynamic object 504, accessed a website or other network location associated with the third-party system assigned to the object placement, etc.). Further, for each impression of the dynamic object 504 on the landing page 502, the object generation module 106 may determine whether a corresponding user has rejected the dynamic object 504 (e.g., did not interact with the CTA 506, selected an option to dismiss the dynamic object 504, etc.). This statistical information may be provided, in real-time, to the aforementioned intent signal and object bid processor 202 described above in connection with FIG. 2. The intent signal and object bid processor 202 may use this statistical information to dynamically, and in real-time, update the assignment recommendation algorithm 210 described above in connection with FIG. 2 and used to provide recommendations for different object placement and intent signal pairings that may be of interest to different third-party systems.

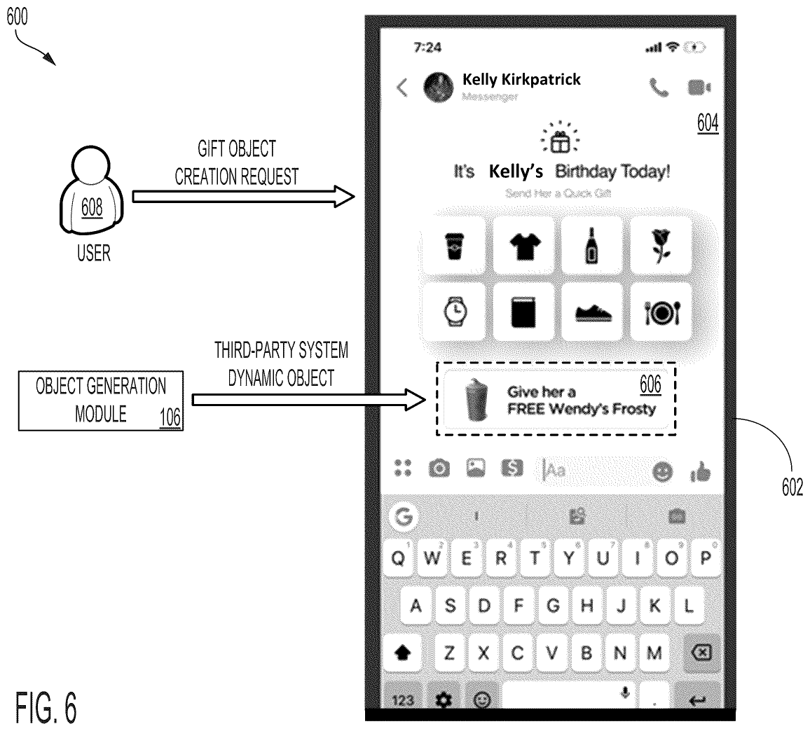

FIG. 6 shows an illustrative example of an environment 600 in which an object generation module 106 dynamically and in real-time generates an object 606 using assets associated with a highest bid and in response to an intent signal corresponding to the presentation of one or more gift selection categories for generating a gift for a recipient in accordance with at least one embodiment. In the environment 600, a user 608, through their computing device 602 (e.g., mobile smartphone, personal computer, laptop, etc.), may be presented with one or more gift selection categories through a landing page 604 associated with a social media platform. The social media platform may be accessed by the user 608 through an application provided by the social media platform and executed on the computing device 602. Alternatively, the user 608 may access the social media platform through a website or other network location associated with the social media platform. This website or other network location may be accessed using a browser application executed on the computing device 602.

The landing page 604, through which the one or more gift selection categories for creation of a gift for an intended recipient, may be accessed through different methods. For instance, the user 608 may determine, from a profile page corresponding to the intended recipient and maintained by the social media platform, that it is the intended recipient's birthday. The social media platform, through this profile page, may provide the user 608 with an option to generate a gift for the intended recipient. If the user 608 selects this option, the social media platform may automatically redirect the user, through the application, to the landing page 604. In some instances, the user 608 may access the landing page 604 without any intervention from the social media platform, such as through the application provided by the social media platform or through their browser application implemented on the computing device 602.

As illustrated in FIG. 6, the landing page 604 may include an object placement, through which a dynamic object 606 may be presented to the user 608. Similar to the object placement described above in connection with FIG. 5, the object placement implemented on the landing page 604 may implement a script or other programmatic code that, when executed by the social media platform that implements the landing page 604, may cause the social media platform to present the dynamic object 606 within the object placement. Further, through this script or other programmatic code, the intent signal object generation service may expose one or more APIs, which the social media platform may use to transmit data corresponding to the landing page 604 and to the user accessing the landing page 604 to the object generation module 106. For instance, through these one or more APIs, the social media platform may transmit data corresponding to the different gift selection categories presented on the landing page 604, as well as information corresponding to the user 608 that accessed the landing page 604 (e.g., identifying information from a user profile corresponding to the user 608, etc.), as well as information corresponding to the intended recipient of the gift (e.g., identifying information from a user profile corresponding to the intended recipient, etc.). For instance, if the user 608 accessed the landing page 604 in response to a CTA presented on the intended recipient's user profile, the social media platform may automatically denote that the user 608 accessed the landing page 604 through interaction with the intended recipient's user profile.

In an embodiment, the object placement included in the landing page 604 is provided to allow for the creation of a dynamic object 606 corresponding to a sponsored gift selection option that may be presented to the user 608 accessing the landing page 604. For instance, a social media platform may include a sponsored gift selection option in any and all of the graphical interfaces or gift situations described herein (e.g., through the landing page 604, etc.). This social media platform may make available this object placement to the intent signal object generation service, which may associate the object placement with different intent signals. These object placement to intent signal pairings may be made available to different third-party systems through any of the processes described herein (e.g., bidding, donation, etc.) such that these object placement to intent signal pairings may be assigned to different third-party systems for generation and presentation of their dynamic objects 606 through these graphical interfaces.

In some instances, the landing page 604 associated with the social media platform is implemented through a gifting application operation in the background of a social media application associated with the social media platform. This gifting application operating in the background of the social media application of the platform may detect an intent signal from the user 608 corresponding to their desire to generate a gift for a recipient and automatically transmit the intent signal, along with information corresponding to the available object placement, to the intent signal object generation service. In response to the intent signal and the information, the intent signal object generation service may automatically, and in real-time, identify a third-party system assigned to the object placement to intent signal pairing corresponding to this intent signal and object placement to identify the dynamic object 606 (e.g., sponsored gift selection option) that is to be presented through the object placement. The intent signal object generation service, through the object generation module 106, may provide any assets corresponding to the dynamic object 606 to the gifting application for generation and presentation of the dynamic object 606 through the object placement.

In response to the data provided by the social media platform, the object generation module 106 may automatically, and in real-time, detect any relevant intent signals that may be used to identify the dynamic object 606 that is to be presented through the object placement. As noted above, the landing page 604 may include one or more gift selection categories for creation of a gift for an intended recipient. Further, the user 608 may have accessed the landing page 604 by selecting a CTA provided by the social media platform on a user profile page associated with an intended recipient as a result of it being the intended recipient's birthday. This information (e.g., the one or more gift selection categories provided on the landing page 604, the user's selection of a CTA corresponding to the intended recipient's birthday, etc.) may be used by the object generation module 106 to detect an intent signal corresponding to a request to generate a gift object that may be delivered to the intended recipient.

Based on this intent signal and identifying information corresponding to the object placement provided on the landing page 604, the object generation module 106 may query the object datastore to determine whether the pairing of the object placement to an intent signal corresponding to a request to create a gift object has been assigned to a particular third-party system. If the pairing has not been assigned to a particular third-party system, the object generation module 106 may generate a default dynamic object through the object placement, as described above. However, if the object placement to intent signal pairing is assigned to a particular third-party system, the object generation module 106 may obtain a set of assets corresponding to a dynamic object 606 associated with the third-party system that is to be presented through the object placement on the landing page 604. For instance, for the dynamic object 606 illustrated in FIG. 6, the object generation module 106 may obtain assets corresponding to the image presented within the object placement (e.g., an image of a Frosty), text to be presented through the object placement and corresponding to the presented image, and assets that may be used to form a CTA that allows the user to interact with the dynamic object 504 in order to perform a desired action (e.g., selection of the dynamic object 606 to redirect the user to a landing page associated with the third-party system, etc.).

As noted above, the landing page 604 may be accessed by the user 608 for a specific purpose, namely to request creation of a gift object for a particular intended recipient (e.g., Kelly Kirkpatrick) to celebrate their birthday. The object generation module 106 may use identifying information associated with the user 608, identifying information associated with the intended recipient, and any other user-specific information (e.g., gifting history, product preferences, etc.) to customize the dynamic object 606 that is presented to the user 608 through the landing page 604. For instance, as illustrated in FIG. 6, the dynamic object 606 may make reference to the intended recipient's gender (e.g., “her”) as determined through any provided user-specific information corresponding to the intended recipient. Further, if the intended recipient has indicated, in previous social media posts published through the social media platform, that they have a preference for smoothies and milkshakes, the object generation module 106 may identify, from the assets provided by the third-party system, any assets corresponding to smoothie or milkshake options provided by the third-party system and use these assets to generate the dynamic object 606. The generation of this customized dynamic object 606 may be performed through the aforementioned machine learning algorithm or artificial intelligence implemented by the object generation module 106, as described above.

As dynamic objects are presented to users through the landing page 604 along with the different gift selection categories for creation of gift objects for intended recipients, the object generation module 106 may monitor, in real-time, user interaction with these dynamic objects to dynamically generate data corresponding to user engagement with these dynamic objects. For instance, for each impression of the dynamic object 606 on the landing page 604, the object generation module 106 may determine whether a corresponding user engaged with the provided dynamic object 606 or selected a different gift selection category presented on the landing page 604. This information may be provided, in real-time, to the aforementioned intent signal and object bid processor 202 described above in connection with FIG. 2. The intent signal and object bid processor 202 may use this information to dynamically, and in real-time, update the assignment recommendation algorithm 210 described above in connection with FIG. 2 and used to provide recommendations for different object placement and intent signal pairings that may be of interest to different third-party systems for object placements within the landing page 604.

In an embodiment, the dynamic object 606 can be provided in parallel to gift selections made from the other gift selection categories presented on the landing page 604. For instance, the user 608 may select the dynamic object 606 to complement a gift selected from any of the other gift selection categories provided through the landing page 604. If the user selects the dynamic object 606, the user 608 may be redirected to a landing page corresponding to the third-party system associated with the dynamic object 606, through which the user 608 may define the parameters for this particular gift for the indicated recipient (e.g., “Kelly Kirkpatrick”). Once the user 608 has defined these parameters for the particular gift associated with the dynamic object 606, the user 608 may be returned to the landing page 604, through which the user 608 may continue to define a different gift through selection of a particular gift selection category from those presented on the landing page 604.

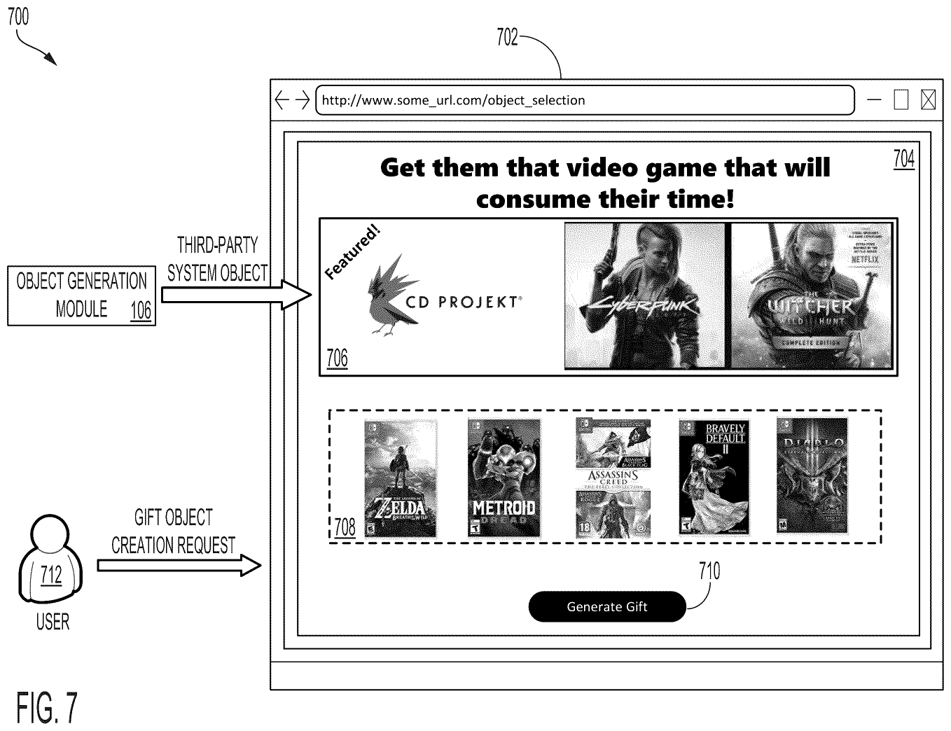

FIG. 7 shows an illustrative example of an environment 700 in which an object generation module 106 dynamically and in real-time generates a dynamic object 706 using assets associated with a highest bid and in response to an intent signal corresponding to a request to generate a gift associated with a particular gift category in accordance with at least one embodiment. In the environment 700, the intent signal object generation service may be associated with a gifting distribution system that implements a platform through which users, such as user 712, may submit requests to generate gift objects for distribution to intended recipients. As illustrated in FIG. 7, the gifting distribution service presents, to a user 712 through a browser application or other application provided by the gifting distribution service that are implemented on their computing device (e.g., smartphone, laptop computer, desktop computer, etc.), an interface through which the user 712 may select one or more gift objects for distribution to an intended recipient. For example, as illustrated in FIG. 7, the user 712 has used their browser application 702 to access an interface provided by the gifting distribution service to generate a gift object that is to be distributed to an intended recipient.

In the environment 700, the user 712, through the interface provided by the gifting distribution service, has navigated to a landing page 704 corresponding to a particular gift category (e.g., video games for a particular video game platform). The gifting distribution service, for this particular gift category, may maintain various gift options that may be presented to the user 712 through the landing page 704. For instance, the gifting distribution service, through the landing page 704, may provide the user 712 with a set of gift options 708 corresponding to different video games that are usable to generate a gift object for an intended recipient. This set of gift options 708 may be organized by the gifting distribution service based on one or more criteria. For instance, the set of gift options 708 may be organized according to the known popularity of these gift options in generating gift objects for different recipients. As another example, the set of gift options 708 may be organized according to an associated resource requirement for selection of a gift option from the set of gift options 708 (e.g., more expensive gift options are listed ahead of less expensive gift options, less expensive gift options are listed ahead of more expensive gift options, etc.). In some instances, the set of gift options 708 may be organized alphabetically according to their assigned titles. While these examples are provided for illustrative purposes, the gifting distribution service may organize the set of gift options 708 according to any contemplated criteria (e.g., by genre, by availability, etc.).

In addition to providing the user 712 with a set of gift options 708 corresponding to a video games gifting category, the gifting distribution service may provide, through the landing page 704, an interface button 710 that can be used by the user 712 to request generation of a gift object according to any selections made on the landing page 704. For example, as illustrated in FIG. 7, the interface button 710 may include text that indicates the purpose of the interface button 710 (e.g., “Generate Gift”). This text may further provide context with regard to the purpose of the landing page 704. Thus, the interface button 710 and accompanying text may be used by the object generation module 106 to further detect an intent signal corresponding to the user's access to the landing page 704 provided by the gifting distribution service.

In an embodiment, and as illustrated in FIG. 7, the landing page 704 associated with the gifting distribution service and the video games gifting category includes an object placement through which one or more dynamic objects may be presented to the user 712. As noted above, an object placement may implement a script or other programmatic code that, when executed, may result in a dynamic object 706 being presented within the object placement. For instance, as the gifting distribution service executes the programmatic code associated with the landing page 704 to present the landing page 704 to the user 712, the gifting distribution service may execute the script or other programmatic code associated with the object placement to generate the dynamic object 706 that is to be presented through the object placement reserved for the presentation of dynamic objects by the object generation module 106. Through this script or other programmatic code, the intent signal object generation service may expose one or more APIs, which the gifting distribution service may use to transmit data corresponding to the landing page 704, to the user 712 accessing the landing page 704, and to the video game gifting category selected by the user 712, to the object generation module 106. For instance, through these one or more APIs, the gifting distribution service may transmit data corresponding to the video game gifting category selected by the user 712 to access the landing page 704, the set of gift options 708 presented on the landing page 704, as well as any available information corresponding to the user 712 that accessed the landing page 704 (e.g., identifying information from a user profile corresponding to the user 712, etc.), as well as information corresponding to the intended recipient of the gift (e.g., identifying information from a user profile corresponding to the intended recipient, etc.).

As with the previously described examples, in response to the data provided by the gifting distribution service in response to the user 712 accessing the landing page 704 (e.g., the gifting category selected by the user 712, the set of gifting options 708, identifying information corresponding to the user 712, identifying information corresponding to the intended recipient, etc.), the object generation module 106 may automatically, and in real-time, detect any relevant intent signals that may be used to identify the dynamic object 706 that is to be presented through the object placement. As illustrated in FIG. 7, the landing page 704 includes a set of gift options 708 that are selectable for creation of a gift object for an intended recipient. Further, the user 712 may have accessed the landing page 704 by selecting a CTA or other option provided by the gifting distribution service and corresponding to a video games gifting category. In some instances, the user 712 may have accessed the landing page 704 in response to selecting a CTA or other option provided by the gifting distribution service through a profile associated with the intended recipient implemented through a social media platform. In such instances, the information obtained by the object generation module 106 may include identifying information associated with the intended recipient (as garnered through the intended recipient's profile), as well as information associated with the user 712 (as garnered through the user's profile maintained by the social media platform, etc.). This collective data may be used by the object generation module 106 to detect an intent signal corresponding to the user's request to generate a gift object corresponding to the video game category and for an intended recipient.

Based on this intent signal, the object generation module 106 may query the object datastore to determine whether the pairing of the object placement on the landing page 704 to an intent signal corresponding to a request to create a video game gift object has been assigned to a particular third-party system. As noted above, if the pairing has not been assigned to a particular third-party system, the object generation module 106 may generate a default dynamic object through the object placement. However, if the object placement to intent signal pairing is assigned to a particular third-party system, the object generation module 106 may obtain a set of assets corresponding to a dynamic object 706 associated with the third-party system that is to be presented through the object placement on the landing page 704. For example, for the dynamic object 706 illustrated in FIG. 7, the object generation module 106 may obtain assets corresponding to different video games associated with a particular video game publisher, which may be the third-party system assigned to the object placement to intent signal pairing. These assets may include images and text corresponding to a set of video games that are to be featured to the user 712 generating a video game gift object for an intended recipient. Further, the identified assets may be presented through the object placement to form a CTA that allows the user to interact with the dynamic object 706 in order to perform a desired action (e.g., selection of an image through the dynamic object 706 to denote the user's selection of a corresponding video game for generation of a gift object, etc.).

As noted above, the object generation module 106 may implement a machine learning algorithm or artificial intelligence that is dynamically trained in real-time to process any user-specific intent signals to determine what dynamic object is to be presented through the object placement. For instance, the object generation module 106 may process any obtained identifying information associated with the user 712 and the intended recipient, along with the intent signal and information corresponding to the object placement, through the machine learning algorithm or artificial intelligence to dynamically generate one or more tailored assets that may be included in the dynamic object 706 that may be specific to the user 712. As an illustrative example, if the object placement to intent signal is assigned to a third-party system that provides video games belonging to different genres, the object generation module 106 may determine, based on the provided identifying information, any user preferences for one or more particular video game genres. Accordingly, the object generation module 106 may obtain any available assets corresponding to video games belonging to these identified genres to generate a dynamic object 706 that highlights these preferences. Through this personalized customization of the dynamic object 706, the object generation module 106 may further entice the user to interact with the dynamic object 706 and select a video game option that is associated with the third-party system assigned to the object placement to intent signal pairing. Based on the user's interaction (or lack thereof) with the dynamic object 706, the machine learning algorithm or artificial intelligence may be dynamically updated, as described above.

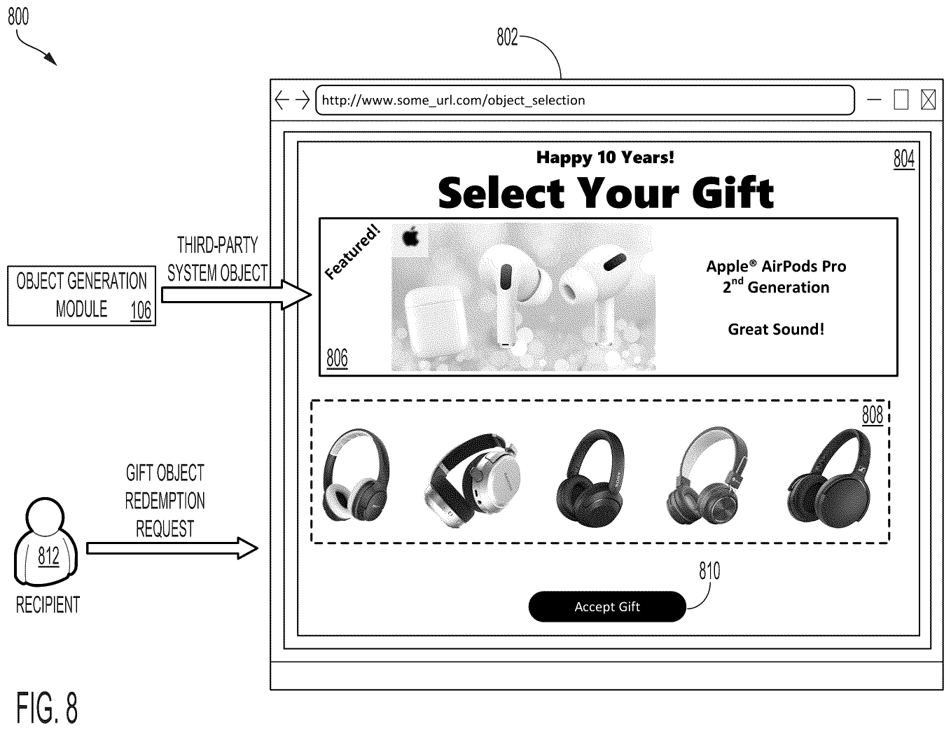

FIG. 8 shows an illustrative example of an environment 800 in which an object generation module 106 dynamically and in real-time generates a dynamic object 806 using assets associated with a highest bid and in response to an intent signal corresponding to a request to redeem a gift object associated with a particular gift category in accordance with at least one embodiment. The environment 800 may be similar to the environment 700 described above in connection with FIG. 7. For instance, in the environment 800, the intent signal object generation service may be associated with the same gifting distribution system that implements a platform through which users may submit requests to generate gift objects for distribution to intended recipients. Further, through this platform, the gifting distribution system may allow recipients of gifts distributed by the gifting distribution service, such as recipient 812, to submit a request to redeem their gift. For example, as illustrated in FIG. 8, the gifting distribution service presents, to a recipient 812 through a browser application or other application provided by the gifting distribution service that are implemented on their computing device (e.g., smartphone, laptop computer, desktop computer, etc.), an interface through which the recipient 812 may select one or more gift objects to redeem their gift. For example, as illustrated in FIG. 8, the recipient 812 has used their browser application 802 to access an interface provided by the gifting distribution service to redeem a gift by selecting a particular gift object that may be provided to the recipient 812.

In an embodiment, the recipient 812 can access the landing page 804 corresponding to a particular gift category (e.g., personal audio headsets) by submitting a request to the gifting distribution service to redeem a gift provided to the recipient 812. For example, the recipient 812 may scan a received card associated with the gift and that encodes data that indicates the particular gift category assigned to the gift. The gifting distribution service, in response to receiving this data, may redirect the recipient 812 to the landing page 804 associated with the particular gift category assigned to the gift that is being redeemed. As another illustrative example, the recipient 812 may navigate to the landing page 804 through selection of a CTA or other option corresponding to the particular gift category as provided by the gifting distribution service through an earlier landing page or interface.

Similar to the environment 700 described above in connection with FIG. 7, the gifting distribution service, for this particular gift category, may maintain various gift options that may be presented to the recipient 812 through the landing page 804. For instance, the gifting distribution service, through the landing page 804, may provide the recipient 812 with a set of gift options 808 corresponding to different personal audio headsets that may be selected by the recipient 812 as their gift. This set of gift options 808 may be organized by the gifting distribution service based on one or more criteria. For instance, the set of gift options 808 may be organized according to the known popularity of these gift options amongst recipients of gifts from different users, whether for the particular gift category or in general. As another example, the set of gift options 808 may be organized according to an associated resource value for selection of a gift option from the set of gift options 808 (e.g., more expensive gift options are listed ahead of less expensive gift options, less expensive gift options are listed ahead of more expensive gift options, etc.). In some instances, the set of gift options 808 may be organized alphabetically according to their assigned titles. While these examples are provided for illustrative purposes, the gifting distribution service may organize the set of gift options 808 according to any contemplated criteria (e.g., by genre, by availability, etc.).

In addition to providing the recipient 812 with a set of gift options 808 corresponding to a personal audio headset gifting category, the gifting distribution service may provide, through the landing page 804, an interface button 810 that can be used by the recipient 812 to accept their gift according to any selections made on the landing page 804. For example, as illustrated in FIG. 8, the interface button 810 may include text that indicates the purpose of the interface button 810 (e.g., “Accept Gift”). This text may further provide context with regard to the purpose of the landing page 804, namely for selecting an item that is to be provided to the recipient 812 in response to a request to redeem their gift. Thus, the interface button 810 and accompanying text may be used by the object generation module 106 to further detect an intent signal corresponding to the recipient's access to the landing page 804.

Similar to the landing page 704 described above in connection with FIG. 7, the landing page 804 associated with the gifting distribution service and the personal audio headset gifting category includes an object placement through which one or more dynamic objects may be presented to the recipient 812. As the gifting distribution service executes the programmatic code associated with the landing page 804 to present the landing page 804 to the recipient 812, the gifting distribution service may execute any scripts or other programmatic code associated with the object placement to generate the dynamic object 806 that is to be presented through the object placement. Through these scripts or other programmatic code, the intent signal object generation service may expose one or more APIs, which the gifting distribution service may use to transmit data corresponding to the landing page 804, to the recipient 812, and to the personal audio headset gifting category associated with the gift object, to the object generation module 106. For instance, through these one or more APIs, the gifting distribution service may transmit data corresponding to the personal audio headset gifting category associated with the gift object or otherwise selected by the recipient 812, the set of gift options 808 presented on the landing page 804, as well as any available information corresponding to the recipient 812 that accessed the landing page 804 (e.g., identifying information from a user profile corresponding to the recipient 812, etc.).

Using this obtained data, the object generation module 106 may detect an intent signal corresponding to the recipient's access to the landing page 804, namely a likely request from the recipient 812 to redeem a gift object through selection of a gift option corresponding to a personal audio headset gift category. Based on this detected intent signal, the object generation module 106 may query the object datastore to determine whether the pairing of the object placement on the landing page 804 to the intent signal corresponding to a likely request to redeem a gift through selection of a gift option corresponding to a personal audio headset gift category is assigned to a third-party system. As noted above, if the pairing has not been assigned to a particular third-party system, the object generation module 106 may generate a default dynamic object through the object placement. However, if the object placement to intent signal pairing is assigned to a particular third-party system, the object generation module 106 may obtain a set of assets corresponding to a dynamic object 806 associated with the third-party system that is to be presented through the object placement on the landing page 804. As illustrated in FIG. 8, for the dynamic object 806 to be presented through the object placement on the landing page 804, the object generation module 106 may obtain assets corresponding to a personal audio headset associated with the third-party system assigned to the object placement to intent signal pairing. These assets may include images and text corresponding to a particular personal audio headset that is to be featured to the recipient 812 looking to redeem their gift object for a personal audio headset. Further, the identified assets may be presented through the object placement to form a CTA that allows the recipient 812 to interact with the dynamic object 806 in order to select the featured personal audio headset for redemption of their gift object.

In an embodiment, the object generation module 106 processes any obtained identifying information associated with the recipient 812, along with the intent signal and information corresponding to the object placement, through the aforementioned machine learning algorithm or artificial intelligence to dynamically generate one or more tailored assets that may be included in the dynamic object 806 in order to customize the dynamic object 806 for the recipient 812. As an illustrative example, if the object placement to intent signal is assigned to a third-party system that provides different types of personal audio headsets, the object generation module 106 may determine, based on the provided identifying information, any recipient preferences for one or more particular styles of personal audio headsets (e.g., closed-back, open-back, on-car, over-car, in-car, earbuds, wireless, noise-canceling, etc.). Accordingly, the object generation module 106 may obtain any available assets corresponding to a particular personal audio headset provided by the third-party system that may be preferred by the recipient 812 to generate the dynamic object 806. For example, as illustrated in FIG. 8, the dynamic object 806 may correspond to a particular set of earbuds associated with the third-party system assigned to the object placement to intent signal pairing. The selection of earbuds may correspond to the recipient's preference for this style of personal audio headset, as determined through prior purchase history, social media postings, and other information garnered about the recipient 812. Based on the recipient's interaction (or lack thereof) with the dynamic object 806, the machine learning algorithm or artificial intelligence may be dynamically updated, as described above.

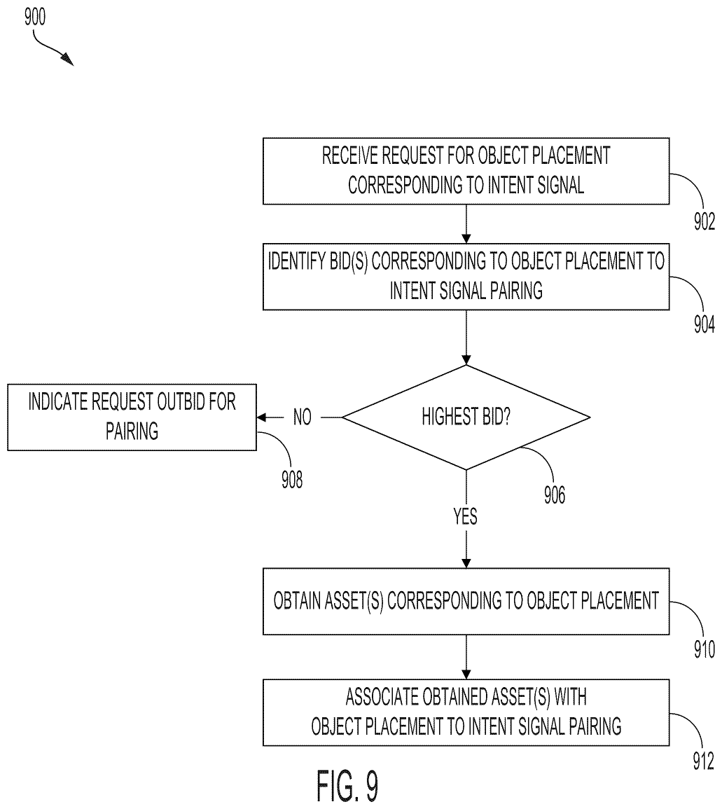

FIG. 9 shows an illustrative example of a process 900 for associating a set of assets corresponding to a set of object placements associated with a particular intent signal based on received bids for the set of object placements in accordance with at least one embodiment. The process 900 may be performed by an object placement request processor implemented by the intent signal object generation service. As noted above, the object placement request processor may process different bids for available object placement to intent signal pairings that are not assigned to any third-party system for generation and presentation of dynamic objects. Further, the object placement request processor, once a bidding process has concluded for a particular object placement to intent signal pairing, the object placement request processor may assign this pairing to the third-party system that submitted the highest bid for the pairing.

At step 902, the object placement request processor may receive a request for object placements corresponding to a particular intent signal. As noted above, the intent signal object generation service makes available different object placements maintained by the intent signal object generation service for use in presenting different dynamic objects according to detected intent signals. These object placements may be implemented through different websites, applications, and/or other network objects and through which dynamic objects may be presented to users when these users access these different websites, applications, and/or other network objects. For example, the intent signal object generation service may maintain a relationship with a particular web server that may maintain websites corresponding to different items made available through an online marketplace. Through these websites, the intent signal object generation service may maintain a set of object placements through which dynamic objects may be presented to users accessing these websites according to any detected intent signals. The available object placements may be categorized by the intent signal object generation service according to different intent signals that may be detectable and used to determine what dynamic objects may be presented to users through these object placements. For example, while the intent signal object generation service may maintain a particular object placement for a particular website associated with another entity, this particular object placement may be made available to different third-party systems according to different detected intent signals.

The request for object placements corresponding to a particular intent signal may be received through an interface provided to different third-party systems. As noted above, when a third-party system accesses the object placement request processor, such as through the aforementioned interface provided by the object placement request processor, the object placement request processor may identify the myriad intent signals that are detectable by the intent signal object generation service when users access different websites, applications, or other user interfaces through which the intent signal object generation service may maintain different object placements for presentation of different dynamic objects. The object placement request processor, through this interface, may present a listing or other ordering of the intent signals that are detectable by the intent signal object generation service. Through the interface, a third-party system may determine which intent signals that the third-party system may be interested in for providing dynamic objects to users in response to these intent signals. In response to a selection of a particular intent signal, the object placement request processor may update the interface to provide a listing or ordering of available object placements corresponding to the selected intent signal and through which dynamic objects may be presented to users. For instance, the object placement request processor may query an object datastore to identify any object placement to intent signal pairings corresponding to the selected intent signal that have not been assigned to other third-party systems. Thus, through this interface, a third-party system may select a particular intent signal and any corresponding object placements through which dynamic objects may be presented in response to the particular intent signal.

At step 904, the object placement request processor may identify any current bids corresponding to the object placement to intent signal pairings selected by the third-party system. As noted above, any available object placement to intent signal pairings may be available to third-party systems through a bidding process, whereby the object placement request processor may open these available pairings to bidding for a limited period of time. Once the period of time has elapsed, the object placement request processor may automatically assign the pairing to the third-party system that submitted the highest bid for this pairing. The current bids corresponding to the one or more pairings of interest indicated in the request may correspond to other third-party systems that may be interested in obtaining these object placement to intent signal pairings for generation and presentation of their dynamic objects in response to the intent signal. In some instances, the request from the third-party system received at step 902 may include a bid for each of the object placement to intent signal pairings that the third-party system is interested in. The bid may indicate an amount of resources that the third-party system is willing to allocate for a corresponding object placement to intent pairing.

At step 906, the object placement request processor may determine whether the third-party system has submitted the highest bid for each of the selected object placement to intent signal pairings indicated in the request. For instance, the object placement request processor may automatically compare the received bid to any previously received bids corresponding to a requested object placement to intent signal pairing to determine whether the third-party system has submitted the highest bid for the pairing. If the third-party system has not submitted the highest bid for the requested pairing, the object placement request processor, at step 908, may indicate that the third-party system has been outbid for the object placement to intent signal pairing. It should be noted that, in some instances, the object placement request processor may provide the third-party system with an indication of the current highest bid for each pairing the third-party system is interested prior to the third-party system submitting its request for these object placement to intent signal pairings. This may allow the third-party system to determine the current highest bid for each pairing and determine whether to submit a bid that is greater than the current highest bid. In some instances, the object placement request processor may automatically reject any request from the third-party system that does not include a bid greater than the current highest bid for a requested pairing.

If the object placement request processor determines that the third-party system has submitted the highest bid for a particular object placement to intent signal pairing, and the allotted period of time for bidding on this pairing has elapsed, the object placement request processor, at step 910, may obtain a set of assets corresponding to the object placement that may be used to generate one or more dynamic objects that may be presented through this object placement in response to the corresponding intent signal. For example, the object placement request processor may automatically prompt the third-party system to provide any assets corresponding to the set of dynamic objects that are to be presented through the corresponding object placement in response to the intent signal. As noted above, these assets may include images, videos, text, or any other data that may be presented through a dynamic object implemented through object placements provided by the intent signal object generation service. In some instances, the assets may further include programmatic code and/or scripts that may be executed through a dynamic object implemented through the aforementioned object placements. The object placement request processor may automatically store any obtained assets from the third-party system and associated with the assigned object placement to intent signal pairing in the object datastore described herein.

At step 912, the object placement request processor may associate the obtained assets with the object request to intent response pairing. For instance, in response to obtaining the assets that may be used to generate dynamic objects presentable through the object placement to which the third-party system is assigned according to a particular intent signal, the object placement request processor may update the entry corresponding to the object placement to associate these assets with the particular object placement to intent signal pairing assigned to the third-party system. For example, through this entry, the object placement request processor may indicate the network location of these assets, as well as identifying information corresponding to these assets.

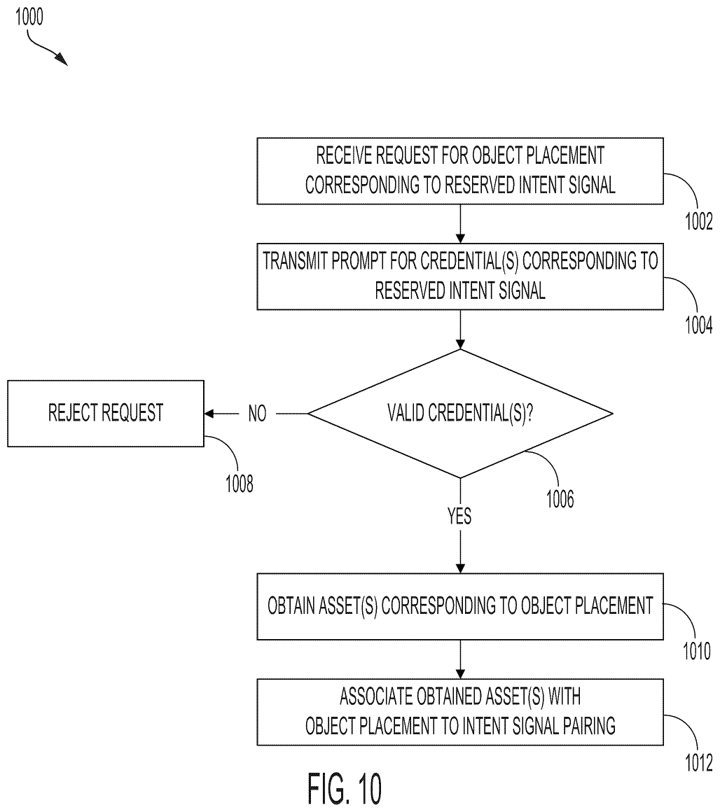

FIG. 10 shows an illustrative example of a process 1000 for associated a set of assets corresponding to a set of object placements associated with a reserved intent signal based on requests from authorized third-party systems associated with the reserved intent signal in accordance with at least one embodiment. The process 1000 may be performed by an object placement request processor implemented by the intent signal object generation service. As noted above, the object placement request processor may process different requests for available object placement to intent signal pairings corresponding to particular intent signals that are reserved for certain types of third-party systems (e.g., third-party systems associated with charitable organizations, etc.) according to different criteria. Based to these criteria, the object placement request processor may assign this pairing to the third-party system that submitted the request so long as the third-party system is authorized to obtain object placements corresponding to the reserved intent signal.

At step 1002, the object placement request processor may receive a request for an object placement corresponding to a reserved intent signal. As noted above, the intent signal object generation service may designate a particular set of object placement to intent signal pairings as being made available for free to third-party systems that provide charitable services or otherwise provide relief and/or aid to others for different purposes (e.g., natural disaster relief, refugee assistance, homeless services, family assistance for serious illnesses, etc.). This designation may be implemented through reservation of one or more intent signals corresponding to these different purposes. Returning to an illustrative example described above, an intent signal corresponding to a user intent to learn more or take action with regard to a natural disaster may be reserved for third-party systems that provide relief or aid services for such natural disasters. As another illustrative example, an intent signal corresponding to a user attempting to learn more about a serious medical condition (e.g., cancer, heart disease, etc.) may be reserved for third-party systems associated with organizations that provide services related to this serious medical condition (e.g., charitable organizations associated with the medical condition, medical service providers, pharmaceutical manufacturers, etc.).

In order for a third-party system to be eligible for an object placement to intent signal pairing associated with a reserved intent signal, the third-party system may be required to provide a set of credentials that may be used to verify this eligibility. Accordingly, at step 1004, the object placement request processor may transmit a prompt to the third-party system that submitted the request for a set of credentials that may be used to verify that the third-party system is eligible to obtain the object placement to intent signal pairing corresponding to the reserved intent signal. As noted above, in some instances, the intent signal object generation service may provide a third-party system with a token that may be used to verify that the third-party system has been vetted by the intent signal object generation service as being associated with a charitable organization or any other entity for which object placements may be made available for particular reserved intent signals. This vetting process may be performed by the intent signal object generation service during an onboarding of the third-party system to the service. During this vetting process, the third-party system may be required to provide any credentials demonstrating that they are associated with a charitable organization (e.g., documentation indicating their Internal Revenue Service status as a 501(c)(3) organization, etc.). These credentials may be evaluated by the intent signal object generation service to determine whether the third-party system qualifies for association with a reserved intent signal. Thus, the object placement request processor may prompt the third-party system to provide their token for authentication of the third-party system as being associated with a charitable organization that may be authorized to obtain the object placement to intent signal pairing for the reserved intent signal.

In some instances, the object placement request processor may allow the third-party system to provide any credentials that may be used to perform the aforementioned vetting process in response to the third-party system's submitted request. For instance, the third-party system, in response to the prompt from the object placement request processor, may provide any credentials or other documentation that may be processed by the object placement request processor to vet the third-party system as being associated with a charitable organization that may be provided with object placement to intent signal pairings corresponding to the reserved intent signal indicated in the third-party system's request.

At step 1006, the object placement request processor may determine whether the third-party system has provided a valid set of credentials corresponding to the reserved intent signal. For instance, if the third-party system has provided a cryptographic token generated by the intent signal object generation service during the aforementioned onboarding process, the object placement request processor may decrypt the cryptographic token to obtain identifying information associated with the third-party system that may be used to determine whether the third-party system is associated with a charitable organization or other entity that has been associated with the reserved intent signal. If the third-party system, in lieu of providing a cryptographic token or other credentials generated by the intent signal object generation service, has provided other credentials or documentation for vetting of the third-party system, the object placement request processor may evaluate the provided other credentials or documentation to determine whether the third-party system may be associated with the reserved intent signal, as described above.

If the object placement request processor determines that the third-party system has not provided a valid set of credentials corresponding to the reserved intent signal, the object placement request processor, at step 1008, may reject the request submitted by the third-party system. For instance, if the object placement request processor determines that a provided set of credentials corresponds to a different reserved intent signal or otherwise is not associated with the reserved intent signal indicated in the request, the object placement request processor may deny this request. Similarly, if the third-party system has provided an expired set of credentials, the object placement request processor may determine that the third-party system cannot be authenticated for the reserved intent signal and, thus, reject the request. If the third-party system has provided other credentials or documentation for vetting of the third-party system, and the object placement request processor determines that the third-party system cannot be associated with the reserved intent signal (e.g., the third-party system is not associated with an organization or other entity that can be associated with the intent signal, the provided other credentials or documentation are not valid, etc.), the object placement request processor may reject the request.

If the object placement request processor determines that the third-party system has provided a valid set of credentials, whereby the third-party system is authorized to obtain an object placement to intent signal pairing associated with the reserved intent signal, the object placement request processor, at step 1010, may obtain a set of assets corresponding to the object placement that may be used to generate one or more dynamic objects that may be presented through this object placement in response to the reserved intent signal. For example, the object placement request processor may automatically prompt the third-party system to provide any assets corresponding to the set of dynamic objects that are to be presented through the corresponding object placement in response to the reserved intent signal. The object placement request processor may automatically store any obtained assets from the third-party system and associated with the assigned object placement to intent signal pairing in the object datastore described herein.

At step 1012, the object placement request processor may associate the obtained assets with the object request to intent response pairing. For instance, in response to obtaining the assets that may be used to generate dynamic objects presentable through the object placement to which the third-party system is assigned according to a particular intent signal, the object placement request processor may update the entry corresponding to the object placement to associate these assets with the particular object placement to intent signal pairing assigned to the third-party system. For example, through this entry, the object placement request processor may indicate the network location of these assets, as well as identifying information corresponding to these assets.

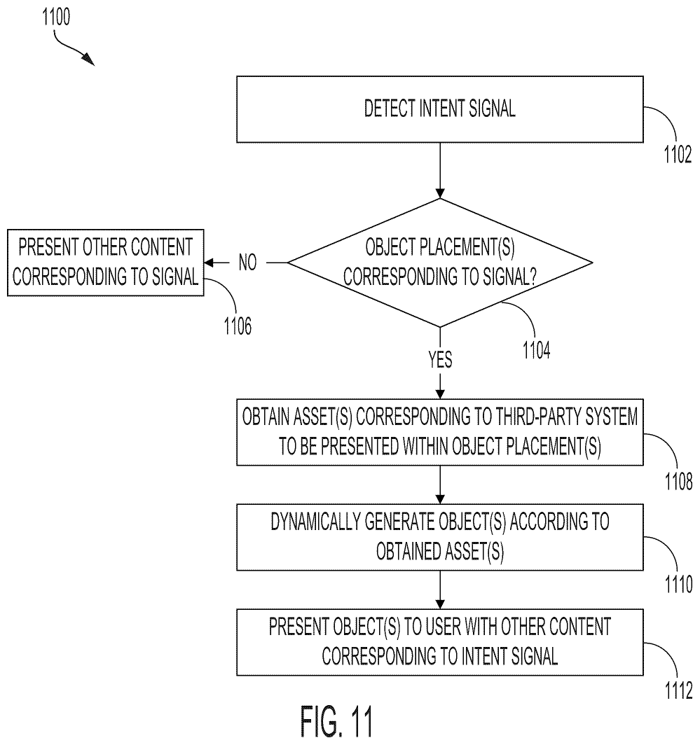

FIG. 11 shows an illustrative example of a process 1100 for dynamically generating one or more objects corresponding to a detected intent signal using a set of assets corresponding a highest bid obtained for object placements associated with the intent signal in accordance with at least one embodiment. The process 1100 may be performed by an object generation module implemented by the intent signal object generation service. As noted above, the object generation module may automatically, and in real-time, detect intent signals corresponding to user access to a website, application, and/or other network object through which the intent signal object generation service maintains one or more object placements. Through these one or more object placements, the object generation module may generate and present different dynamic objects based on the detected intent signal, as described in greater detail herein.

At step 1102, the object generation module may automatically detect, in real-time, an intent signal. As noted above, when a user accesses a website, application, or other network object, any available scripts or other programmatic code associated with the website, application, or other network object may be executed to present the content associated with the website, application, or other network object to the user. For each object placement maintained within the website, application, or other network object, the intent signal object generation service may implement a script or other programmatic code that may expose one or more APIs that may be used to transmit data corresponding to the website, application, or other network object and to the user accessing the website, application, or other network object to the object generation module. For instance, through these one or more APIs, a web server may transmit data corresponding to the various elements presented on a website (e.g., data objects presented on the website, information presented on the website, etc.), as well as the characteristics of the website (e.g., identifying information corresponding to the owner of the website, information indicating the purpose of the website, etc.). Accordingly, the object generation module may use this data to automatically, and in real-time, detect an intent signal corresponding to user's access to the website, application, or other network object.

At step 1104, the object generation module may determine whether pairings of the different object placements with the detected intent signal are currently assigned to any third-party systems. As noted above, a third-party system may be assigned to a particular object placement to intent signal pairing according to a bidding process, such as the process 900 described above in connection with FIG. 9. This assignment may be recorded within an entry corresponding to the particular object placement in an object datastore. Accordingly, for each object placement present within the particular website, application, or other network object accessed by the user, the object generation module may automatically, and in real-time, evaluate each entry corresponding to each object placement to determine whether the object placement, for the detected intent signal, is currently assigned to a particular third-party system.

If the object generation module determines that an object placement to intent signal pairing has not been assigned to a particular third-party system (e.g., the pairing is unassigned, a previous assignment corresponding to the pairing is expired, etc.), the object generation module, at step 1106, may present other content corresponding to the intent signal through the object placement. For instance, the object generation module may generate a default dynamic object through the object placement. This default dynamic object may not be tied to any third-party system. Alternatively, the default dynamic object may be generated randomly from a pool of default dynamic objects associated with different third-party systems and/or to the intent signal object generation service itself. In some instances, the default dynamic object may be selected from a pool of default dynamic objects maintained by the intent signal object generation service according to the detected intent signal. For example, if the intent signal corresponds to a request to generate a gift object for an intended recipient, the object generation module may tailor the default dynamic object such that the default dynamic object makes reference to this request (e.g., includes the text “Get them the perfect gift!,” etc.).

If the object generation module determines that an object placement to intent signal pairing is assigned to a particular third-party system, the object generation module, at step 1108, may obtain one or more assets corresponding to this particular third-party system that may be used to generate a dynamic object to be presented through this object placement. For instance, an entry corresponding to an object placement may indicate, for a particular intent signal, network locations where assets usable to generate a dynamic object that may be presented through the object placement are available. These assets may include images, videos, text, or any other data that may be presented through a dynamic object implemented through object placements provided by the intent signal object generation service. In some instances, the assets may further include programmatic code and/or scripts that may be executed through a dynamic object implemented through the aforementioned object placements. The object generation module may access these network locations specified in the entry corresponding to the object placement to obtain these assets. In some instances, if the entry does not specify a network location for retrieval of these assets, the object generation module may prompt the third-party system assigned to the object placement to intent signal pairing to obtain the set of assets required to generate a dynamic object within the object placement.

At step 1110, the object generation module may use the obtained assets to dynamically generate a dynamic object that may be presented through the object placement in response to the detected intent signal. For instance, the object generation module may use configuration information associated with the dynamic object that is to be presented through the object placement to generate the dynamic object. This configuration information may include parameters for presenting the dynamic object associated with the object placement to intent signal pairing upon detection of the intent signal. These parameters may include dimensions associated with the dynamic object, any assets that are to be executed within website, application, or other network object in order to present the dynamic object within the object placement, and the like. Based on this configuration information, the object generation module may configure the dynamic object and the object placement to allow, at step 1112, for presentation of the dynamic object to the user accessing the website, application, or other network object in response to the intent signal associated with the user.

It should be noted that, in some instances, the process 1100 may include additional and/or alternative steps. For instance, in an embodiment, the object generation module implements a machine learning algorithm or artificial intelligence that is dynamically trained in real-time to process any obtained identifying information associated with the user, along with the intent signal and information corresponding to the object placement, to dynamically generate one or more tailored assets that may be included in the dynamic object that may be specific to the user. As an illustrative example, if the object placement to intent signal pairing is assigned to a third-party system that provides video games belonging to different genres, the object generation module may determine, based on the provided identifying information associated with the user, any user preferences for one or more particular video game genres. Accordingly, the object generation module may obtain any available assets corresponding to video games belonging to these identified genres to generate a dynamic object that highlights these preferences. Through this personalized customization of the dynamic object, the object generation module may further entice the user to interact with the dynamic object that is associated with the third-party system assigned to the object placement to intent signal pairing. Based on the user's interaction (or lack thereof) with the dynamic object, the machine learning algorithm or artificial intelligence may be dynamically updated, as described above.

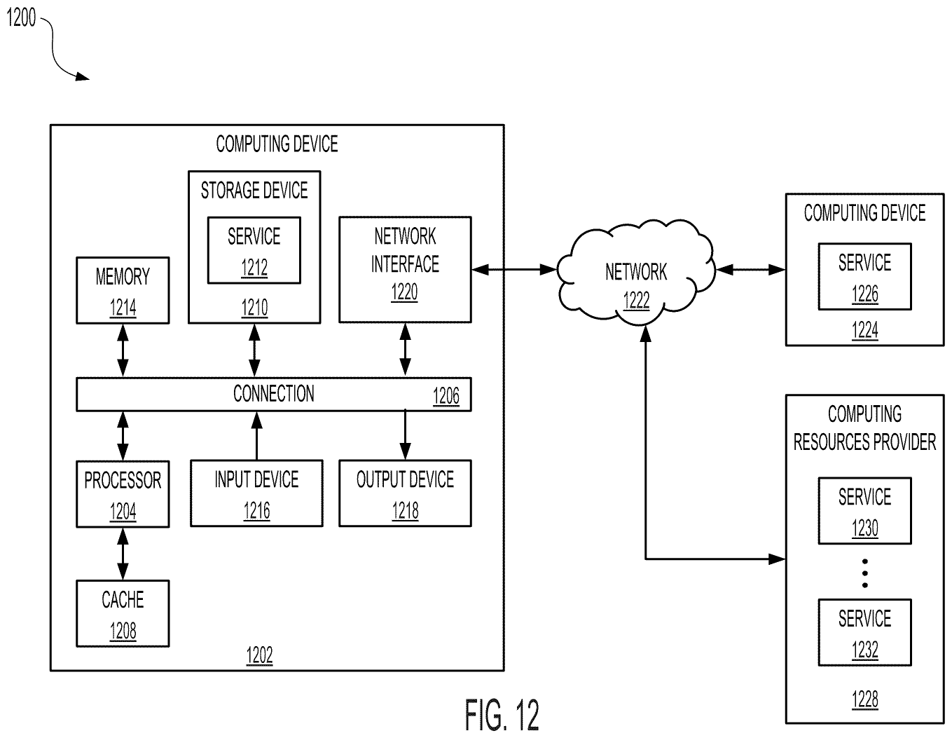

FIG. 12 illustrates a computing system architecture 1200, including various components in electrical communication with each other, in accordance with some embodiments. The example computing system architecture 1200 illustrated in FIG. 12 includes a computing device 1202, which has various components in electrical communication with each other using a connection 1206, such as a bus, in accordance with some implementations. The example computing system architecture 1200 includes a processing unit 1204 that is in electrical communication with various system components, using the connection 1206, and including the system memory 1214. In some embodiments, the system memory 1214 includes read-only memory (ROM), random-access memory (RAM), and other such memory technologies including, but not limited to, those described herein. In some embodiments, the example computing system architecture 1200 includes a cache 1208 of high-speed memory connected directly with, in close proximity to, or integrated as part of the processor 1204. The system architecture 1200 can copy data from the memory 1214 and/or the storage device 1210 to the cache 1208 for quick access by the processor 1204. In this way, the cache 1208 can provide a performance boost that decreases or eliminates processor delays in the processor 1204 due to waiting for data. Using modules, methods and services such as those described herein, the processor 1204 can be configured to perform various actions. In some embodiments, the cache 1208 may include multiple types of cache including, for example, level one (L1) and level two (L2) cache. The memory 1214 may be referred to herein as system memory or computer system memory. The memory 1214 may include, at various times, elements of an operating system, one or more applications, data associated with the operating system or the one or more applications, or other such data associated with the computing device 1202.

Other system memory 1214 can be available for use as well. The memory 1214 can include multiple different types of memory with different performance characteristics. The processor 1204 can include any general purpose processor and one or more hardware or software services, such as service 1212 stored in storage device 1210, configured to control the processor 1204 as well as a special-purpose processor where software instructions are incorporated into the actual processor design. The processor 1204 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 1204 can be a microprocessor, a microcontroller, a digital signal processor (“DSP”), or a combination of these and/or other types of processors. In some embodiments, the processor 1204 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 1200, an input device 1216 can represent any number of input mechanisms, such as a microphone for speech, a touch-sensitive screen for gesture or graphical input, keyboard, mouse, motion input, pen, and other such input devices. An output device 1218 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 1200. In some embodiments, the input device 1216 and/or the output device 1218 can be coupled to the computing device 1202 using a remote connection device such as, for example, a communication interface such as the network interface 1220 described herein. In such embodiments, the communication interface can govern and manage the input and output received from the attached input device 1216 and/or output device 1218. As may be contemplated, there is no restriction on operating on any particular hardware arrangement and accordingly the basic features here may easily be substituted for other hardware, software, or firmware arrangements as they are developed.

In some embodiments, the storage device 1210 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 1210 can include hardware and/or software services such as service 1212 that can control or configure the processor 1204 to perform one or more functions including, but not limited to, the methods, processes, functions, systems, and services described herein in various embodiments. In some embodiments, the hardware or software services can be implemented as modules. As illustrated in example computing system architecture 1200, the storage device 1210 can be connected to other parts of the computing device 1202 using the system connection 1206. In an embodiment, a hardware service or hardware module such as service 1212, that performs a function can include a software component stored in a non-transitory computer-readable medium that, in connection with the necessary hardware components, such as the processor 1204, connection 1206, cache 1208, storage device 1210, memory 1214, input device 1216, output device 1218, and so forth, can carry out the functions such as those described herein.

The disclosed processed for generating dynamic objects in response to detected intent signals can be performed using a computing system such as the example computing system illustrated in FIG. 12, using one or more components of the example computing system architecture 1200. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and functions for generating dynamic objects in response to detected intent signals described herein by, for example, executing code using a processor such as processor 1204 wherein the code is stored in memory such as memory 1214 as described herein. One or more of a user device, a provider server or system, a database system, or other such devices, services, or systems may include some or all of the components of the computing system such as the example computing system illustrated in FIG. 12, using one or more components of the example computing system architecture 1200 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 1228. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 1204 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 1214 can be coupled to the processor 1204 by, for example, a connector such as connector 1206, or a bus. As used herein, a connector or bus such as connector 1206 is a communications system that transfers data between components within the computing device 1202 and may, in some embodiments, be used to transfer data between computing devices. The connector 1206 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 1214 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 1214 can also include magnetic or optical data storage media including read-only (e.g., CD ROM and DVD ROM) or otherwise (e.g., CD or DVD). The memory can be local, remote, or distributed.

As described above, the connector 1206 (or bus) can also couple the processor 1204 to the storage device 1210, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data is may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 1210. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 1206 can also couple the processor 1204 to a network interface device such as the network interface 1220. The interface can include one or more of a modem or other such network interfaces including, but not limited to those described herein. It will be appreciated that the network interface 1220 may be considered to be part of the computing device 1202 or may be separate from the computing device 1202. The network interface 1220 can include one or more of an analog modem, Integrated Services Digital Network (ISDN) modem, cable modem, token ring interface, satellite transmission interface, or other interfaces for coupling a computer system to other computer systems. In some embodiments, the network interface 1220 can include one or more input and/or output (I/O) devices. The I/O devices can include, by way of example but not limitation, input devices such as input device 1216 and/or output devices such as output device 1218. For example, the network interface 1220 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, cCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 1202 can be connected to one or more additional computing devices such as computing device 1224 via a network 1222 using a connection such as the network interface 1220. In such embodiments, the computing device 1224 may execute one or more services 1226 to perform one or more functions under the control of, or on behalf of, programs and/or services operating on computing device 1202. In some embodiments, a computing device such as computing device 1224 may include one or more of the types of components as described in connection with computing device 1202 including, but not limited to, a processor such as processor 1204, a connection such as connection 1206, a cache such as cache 1208, a storage device such as storage device 1210, memory such as memory 1214, an input device such as input device 1216, and an output device such as output device 1218. In such embodiments, the computing device 1224 can carry out the functions such as those described herein in connection with computing device 1202. In some embodiments, the computing device 1202 can be connected to a plurality of computing devices such as computing device 1224, each of which may also be connected to a plurality of computing devices such as computing device 1224. Such an embodiment may be referred to herein as a distributed computing environment.

The network 1222 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 1222 can be wired connections, wireless connections, or combinations thereof. Communications via the network 1222 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 1222, within the computing device 1202, within the computing device 1224, or within the computing resources provider 1228 can include information, which also may be referred to herein as content. The information may include text, graphics, audio, video, haptics, and/or any other information that can be provided to a user of the computing device such as the computing device 1202. In an embodiment, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 1202 and presented to a user of the computing device 1202 using forms that are perceptible via sight, sound, smell, taste, touch, or other such mechanisms. In some embodiments, communications over the network 1222 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 1202 and/or the computing device 1224 can be connected to a computing resources provider 1228 via the network 1222 using a network interface such as those described herein (e.g. network interface 1220). In such embodiments, one or more systems (e.g., service 1230 and service 1232) hosted within the computing resources provider 1228 (also referred to herein as within “a computing resources provider environment”) may execute one or more services to perform one or more functions under the control of, or on behalf of, programs and/or services operating on computing device 1202 and/or computing device 1224. Systems such as service 1230 and service 1232 may include one or more computing devices such as those described herein to execute computer code to perform the one or more functions under the control of, or on behalf of, programs and/or services operating on computing device 1202 and/or computing device 1224.

For example, the computing resources provider 1228 may provide a service, operating on service 1230 to store data for the computing device 1202 when, for example, the amount of data that the computing device 1202 exceeds the capacity of storage device 1210. In another example, the computing resources provider 1228 may provide a service to first instantiate a virtual machine (VM) on service 1232, use that VM to access the data stored on service 1232, perform one or more operations on that data, and provide a result of those one or more operations to the computing device 1202. Such operations (e.g., data storage and VM instantiation) may be referred to herein as operating “in the cloud,” “within a cloud computing environment,” or “within a hosted virtual machine environment,” and the computing resources provider 1228 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 1228 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, serverless hosting, virtual reality (VR) systems, and augmented reality (AR) systems. Various techniques to facilitate such services include, but are not be limited to, virtual machines, virtual storage, database services, system schedulers (e.g., hypervisors), resource management systems, various types of short-term, mid-term, long-term, and archival storage devices, etc.

As may be contemplated, the systems such as service 1230 and service 1232 may implement versions of various services (e.g., the service 1212 or the service 1226) on behalf of, or under the control of, computing device 1202 and/or computing device 1224. Such implemented versions of various services may involve one or more virtualization techniques so that, for example, it may appear to a user of computing device 1202 that the service 1212 is executing on the computing device 1202 when the service is executing on, for example, service 1230. As may also be contemplated, the various services operating within the computing resources provider 1228 environment may be distributed among various systems within the environment as well as partially distributed onto computing device 1224 and/or computing device 1202.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 1202) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the processes illustrated in FIGS. 9-11). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistant (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 1202.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method, comprising:
receiving a request to generate a dynamic object through an object placement in response to an intent signal, wherein the request indicates a resource amount allocated for the request, and wherein the object placement is implemented through a network object;
identifying other requests to generate other dynamic objects through the object placement in response to the intent signal, wherein the other requests indicate other resource amounts for the other requests;
obtaining a set of assets corresponding to the dynamic object, wherein the set of assets are obtained as a result of the resource amount allocated for the request being greater than the other resource amounts;
detecting in real-time the intent signal, wherein the intent signal is detected in real-time in response to user access to the network object; and
generating the dynamic object, wherein the dynamic object is generated using the set of assets, and wherein the dynamic object is generated through the object placement.

2. The computer-implemented method of claim 1, further comprising:
dynamically training in real-time a machine learning algorithm to customize dynamic objects according to received user data, wherein the machine learning algorithm is dynamically trained in real-time using sample user data and feedback corresponding to dynamic objects generated according to the sample user data; and
customizing the dynamic object according to the user access, wherein the dynamic object is customized by the machine learning algorithm based on the user access.

3. The computer-implemented method of claim 1, further comprising:
assigning a pairing of the object placement to the intent signal to a requesting system associated with the request as a result of the resource amount allocated for the request being greater than the other resource amounts, wherein the pairing is assigned to the requesting system subject to an expiration date after which the pairing is made available to other systems.

4. The computer-implemented method of claim 1, wherein the object placement is associated with one or more application programming interfaces (APIs) that are exposed when the network object is accessed, and wherein when the user access is performed, the APIs are used to detect the intent signal.

5. The computer-implemented method of claim 1, wherein the set of assets are obtained as a result of the resource amount allocated for the request being greater than a reserve resource amount designated for the object placement and the intent signal.

6. The computer-implemented method of claim 1, wherein the set of assets are obtained as a result of a number corresponding to the other requests being greater than a minimum number of requests designated for the object placement and the intent signal.

7. The computer-implemented method of claim 1, wherein the set of assets include configuration information corresponding to the object placement, and wherein when the dynamic object is generated, the configuration information is used to configure the object placement for the dynamic object.

8. A system, comprising:
one or more processors; and
memory storing thereon instructions that, as a result of being executed by the one or more processors, cause the system to:
receive a request to generate a dynamic object through an object placement in response to an intent signal, wherein the request indicates a resource amount allocated for the request, and wherein the object placement is implemented through a network object;
identify other requests to generate other dynamic objects through the object placement in response to the intent signal, wherein the other requests indicate other resource amounts for the other requests;
obtain a set of assets corresponding to the dynamic object, wherein the set of assets are obtained as a result of the resource amount allocated for the request being greater than the other resource amounts;
detect in real-time the intent signal, wherein the intent signal is detected in real-time in response to user access to the network object; and
generate the dynamic object, wherein the dynamic object is generating using the set of assets, and wherein the dynamic object is generated through the object placement.

9. The system of claim 8, wherein the instructions further cause the system to:
dynamically train in real-time a machine learning algorithm to customize dynamic objects according to received user data, wherein the machine learning algorithm is dynamically trained in real-time using sample user data and feedback corresponding to dynamic objects generated according to the sample user data; and
customize the dynamic object according to the user access, wherein the dynamic object is customized by the machine learning algorithm based on the user access.

10. The system of claim 8, wherein the instructions further cause the system to:
assign a pairing of the object placement to the intent signal to a requesting system associated with the request as a result of the resource amount allocated for the request being greater than the other resource amounts, wherein the pairing is assigned to the requesting system subject to an expiration date after which the pairing is made available to other systems.

11. The system of claim 8, wherein the object placement is associated with one or more application programming interfaces (APIs) that are exposed when the network object is accessed, and wherein when the user access is performed, the APIs are used to detect the intent signal.

12. The system of claim 8, wherein the set of assets are obtained as a result of the resource amount allocated for the request being greater than a reserve resource amount designated for the object placement and the intent signal.

13. The system of claim 8, wherein the set of assets are obtained as a result of a number corresponding to the other requests being greater than a minimum number of requests designated for the object placement and the intent signal.

14. The system of claim 8, wherein the set of assets include configuration information corresponding to the object placement, and wherein when the dynamic object is generated, the configuration information is used to configure the object placement for the dynamic object.

15. A non-transitory, computer-readable storage medium storing thereon executable instructions that, as a result of being executed by one or more processors of a computer system, cause the computer system to:
receive a request to generate a dynamic object through an object placement in response to an intent signal, wherein the request indicates a resource amount allocated for the request, and wherein the object placement is implemented through a network object;
identify other requests to generate other dynamic objects through the object placement in response to the intent signal, wherein the other requests indicate other resource amounts for the other requests;
obtain a set of assets corresponding to the dynamic object, wherein the set of assets are obtained as a result of the resource amount allocated for the request being greater than the other resource amounts;
detect in real-time the intent signal, wherein the intent signal is detected in real-time in response to user access to the network object; and
generate the dynamic object, wherein the dynamic object is generating using the set of assets, and wherein the dynamic object is generated through the object placement.

16. The non-transitory, computer-readable storage medium of claim 15, wherein the executable instructions further cause the computer system to:
dynamically train in real-time a machine learning algorithm to customize dynamic objects according to received user data, wherein the machine learning algorithm is dynamically trained in real-time using sample user data and feedback corresponding to dynamic objects generated according to the sample user data; and
customize the dynamic object according to the user access, wherein the dynamic object is customized by the machine learning algorithm based on the user access.

17. The non-transitory, computer-readable storage medium of claim 15, wherein the executable instructions further cause the computer system to:
assign a pairing of the object placement to the intent signal to a requesting system associated with the request as a result of the resource amount allocated for the request being greater than the other resource amounts, wherein the pairing is assigned to the requesting system subject to an expiration date after which the pairing is made available to other systems.

18. The non-transitory, computer-readable storage medium of claim 15, wherein the object placement is associated with one or more application programming interfaces (APIs) that are exposed when the network object is accessed, and wherein when the user access is performed, the APIs are used to detect the intent signal.

19. The non-transitory, computer-readable storage medium of claim 15, wherein the set of assets are obtained as a result of the resource amount allocated for the request being greater than a reserve resource amount designated for the object placement and the intent signal.

20. The non-transitory, computer-readable storage medium of claim 15, wherein the set of assets are obtained as a result of a number corresponding to the other requests being greater than a minimum number of requests designated for the object placement and the intent signal.

21. The non-transitory, computer-readable storage medium of claim 15, wherein the set of assets include configuration information corresponding to the object placement, and wherein when the dynamic object is generated, the configuration information is used to configure the object placement for the dynamic object.
